(19) United States
(12) Patent Application Publication
(10) Pub. No.: US 2010/0307310 A1
(43) Pub. Date: Dec. 9, 2010

(54) Tiles and Apparatus, System and Method for Fabricating Tiles and Tile Patterns

(76) Inventor: Louis K. Justin, Holly, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/784,824

(22) Filed: May 21, 2010

Related U.S. Application Data
(62) Division of application No. 11/274,986, filed on Nov. 16, 2005, now Pat. No. 7,721,776.
(60) Provisional application No. 60/628,426, filed on Nov. 16, 2004.

(51) Int. Cl. B26D 7/18

(52) U.S. Cl. 83/648

(57) ABSTRACT

A router template for fabricating a contoured tile from a workpiece is provided. The router template includes a body that defines a cavity in which a nest is formed for retaining a workpiece during a cutting operation. A bearing path is defined within the body that engages a bearing of the router bit to guide the workpiece relative to the router bit. A cutting path is formed within the body to provide clearance within the body for a rotary cutting portion of the router bit. The cutting path and bearing path are aligned with each other and correspond to the desired size and contour of the tile. A method of cutting a contoured tile by following a template is also disclosed.

### CROSS-REFERENCE TO RELATED APPLICATIONS

This application is a division of U.S. application Ser. No. 11/274,986 filed Nov. 16, 2005, which in turn claims the benefit of U.S. provisional application Ser. No. 60/628,426, filed Nov. 16, 2004.

### BACKGROUND OF THE INVENTION

1. Field of the Invention

The invention relates to tiles, more particularly to tiles and apparatuses, systems and methods for fabricating tiles and tile patterns.

2. Background Art

Conventionally tiles are utilized on floors, walls, furniture or the like to provide an ornamental surface. Often, when tiles are utilized on surfaces such as floors or furniture tops, these surfaces experience pedestrian traffic or wear from objects placed thereupon.

Conventional flooring patterns include simplified patterns and complex patterns. The simplified patterns include wooden flooring and tiles of a uniform polygonal shape, such as rectangular tiles. Neither of which require, nor are provided with, limited tolerances. Minimal gaps are permissible in wood flooring because they generally do not upset the aesthetic appearance of the flooring and the gaps flow in the direction of the flooring and the associated grain patterns. If undesired, such gaps are typically filled with a mixture of sawdust and adhesive that is stained to match the associated flooring. Conventional simplified tiles do not require limited tolerances, because they are generally fabricated from a ceramic, stone or similar material that requires spacing between adjacent tiles and a grout or tile adhesive disposed therebetween. Therefore, variances in tolerances are unnoticed because adjacent tiles do not actually mate with one another.

Conventional semi-complicated tile patterns are typically limited to basic geometric shapes, such as lines, circle arcs and the like, and are limited in tolerances as well. Ceramic or stone tiles are conventionally spaced to receive grouting or tile adhesive therebetween and therefore the lack of precision is unnoticed. In complex wooden tile patterns, such as tiling, flooring, inlays, borders, parquetry and marquetry, tolerances are lacking thereby generating visually noticeable gaps between adjacent tiles. These conventional complex wooden tile patterns are costly and labor intensive and any gaps exacerbate these difficulties by requiring filling in the gaps. The filling is a combination of sawdust and a wood adhesive or lacquer which is stained to create nebulous feature lines. Another difficulty presented in wood tiling is that wooden tiles have a tendency to change shape and size due to humidity, drying, application of finishing materials, or the like. Therefore, when wooden tiles are fabricated by a manufacturer to specific tolerances, these tolerances may change by the time the tiles have gone through channels of distribution and finally reach the user who subsequently installs the tiles.

Other manufacturing methods include waterjet cutting or laser cutting. Such methods are typically unavailable to general public consumers. These methods are also ineffective for some tile materials. Waterjet cutting can not hold a good tolerance in most applications, (e.g., plus or minus 0.015 inches for most materials). Additionally, wood tends to absorb water thereby swelling and resulting in an inaccurately cut tile. Laser cutting can provide a tighter tolerance but is dependent on the refractive index of the materials and the thickness of the material being cut. Wood has a poor refractive index, thereby resulting in an imprecisely cut tile.

Conventional jigs for woodworking are typically limited in scope, functionality, application, quality and tolerance thereby limiting these characteristics of the resultant workpiece. Additionally, conventional woodworking jigs are limited in range of variations and styles. A woodworker must select from a predetermined variety of jigs to machine a workpiece.

Many tile patterns comprise various geometrical shapes, which are derived from mathematics. Mathematically developed patterns known as tessellations are geometric patterns formed by congruent plane figures of one or more types. Tessellations include infinite tessellations, finite tessellations and metamorphosis tessellations. Infinite tessellations also known as two dimensional tessellations because they represent a planar geometry upon a planar surface and are generally derived from Euclidean mathematics. Finite tessellations, also known as three-dimensional tessellations, provide a representation of a three dimensional object illustrated upon a two dimensional surface. Finite tessellations are derived from Euclidian mathematics or non-Euclidean mathematics, such as hyperbolic mathematics, spherical mathematics, or the like. Finite tessellations illustrate, for example, a representation of an infinite tessellation formed about a sphere, yet represented as projected upon a two dimensional planar surface. Tessellations are appreciated by both mathematicians and artists and are commonly associated with the artistry of M. C. Escher.

Due to the complexity of tessellations, they are generally only found in artwork, engravings, prints, posters or the like. Difficulties in reducing tessellated patterns into interlocking tiles is apparent in the prior art. For example, artwork of M. C. Escher has been embodied by tiles such as the glazed tiles in the column at the New Girls' School, in the Hague, circa 1959 and the Tile Mural (First) Liberal Christian Lycum, the Hague, circa 1960. Both of these tile representations do not include a single tile for each geometrical representation. Rather, the geometrical pattern is formed upon conventional rectangular tiles and individual geometrical units are separated by grouted gaps in between adjacent tiles. The prior art has further evolved by providing concrete molds for generating tessellated paver stones that are generally interlocking; however, gaps are provided between adjacent stones as well.

### SUMMARY OF THE INVENTION

According to one aspect of the present invention, a router template for fabricating a tile from a workpiece in a rotary cutting operation of a router having a router bit is provided. The router template comprises a body having a nest formed within the body for retaining the workpiece during the cutting operation. A bearing path is formed within the body for engaging a bearing of the router bit and guiding the workpiece relative to the router bit. The bearing path is sized and contoured to correspond to the desired size and contour of the tile. A cutting path is formed within the body for providing clearance within the body for a rotary cutting portion of the router bit. The cutting path is aligned with the bearing path so that the rotary cutting portion of the router bit cuts the workpiece as the bearing follows the bearing path.

According to another aspect of the invention, a template for moving a workpiece on a table top router as the workpiece is cut to form a contoured product is provided. The router has a bit that is assembled coaxially with a bearing. The template is utilized to cut tiles of a desired shape. The template comprises a body defining a cavity and a nest for retaining the workpiece within the cavity. Means are provided for guiding movement of the template as the workpiece retained in the cavity is moved into engagement with the router bit of the table top router to form the contoured product to the desired shape.

According to another aspect of the invention, a method of cutting a contoured tile by following a template with a table top router having a cutting blade and a bearing is provided. The template is used to guide movement of the workpiece blank in accordance with the method wherein the workpiece blank is inserted into a nest defined within the template. The template is placed on the table top router with the cutting blade of the router disposed within a cutting clearance groove and spaced from the workpiece blank. The template is moved to cause the bearing to engage the bearing path surface formed within the guide body. The bearing traces the bearing path that is patterned after the shape of the contoured tile. The workpiece is cut with the cutting blade as the cutting blade is moved within a clearance groove that is formed within the guide body as the bearing traces the bearing path to form the contoured tile.

According to another aspect of the present invention, a gage may be formed on the body of the router template that may be used to set up the router bit to the proper height prior to performing the cutting operation.

According to other aspects of the invention, the template may be formed to tolerances sufficient to produce tiles that interlock with one another. The template is formed to tolerances that are sufficient to produce tiles of a tessellation pattern. Alternatively stated, the template is formed to tolerances sufficient to produce tiles that mate with one another with minimal gaps, such as gaps that are within ±0.0001 inches.

According to additional aspects of the present invention, the nest may further comprise a recess within the body that is sized to receive the workpiece. The nest may further comprise side walls for retaining the workpiece laterally.

According to other aspects of the invention, the body may comprise a contact surface for engaging a router table from which the router bit extends and is driven rotationally during the cutting operation. The body is manually translated on the contact surface relative to the router bit. The nest may further comprise a recess formed within the body that is sized to receive the workpiece within the nest. The recess may in part comprise a platen that is oriented generally parallel to the contact surface of the body.

According to another aspect of the invention, the bearing path and the cutter path may be stacked in a direction normal to the contact surface.

According to still further aspects of the invention, a window may be formed through the body that opens into a surface that faces in the opposite direction from the contact surface for viewing the cutting operation. The window may further be defined as a viewing slot that is aligned with the cutting path.

According to yet another aspect of the present invention, the router template may comprise a retaining mechanism for retaining the workpiece within the nest. The retaining mechanism may be oriented laterally inboard relative to the cutting path for retaining the workpiece during and after the cutting operation. The retaining mechanism may further be defined as comprising a plurality of pins, such as precision locating pins, that pierce the workpiece to retain the workpiece in the lateral direction. At least one aperture may be formed through the nest for ejecting the workpiece from the nest.

These and other aspects of the present invention will be better understood in view of the attached drawings and the following detailed description of the illustrated embodiments.

### BRIEF DESCRIPTION OF THE DRAWINGS

FIG. 1 is a perspective view of a preferred embodiment router template in accordance with the present invention, the router template is illustrated with an associated workpiece and a finished tile;

FIG. 2 is a perspective view of the router template of FIG. 1, and an exploded perspective view of the router template of FIG. 1;

FIG. 3a is a bottom plan view and a perspective view of the router template of FIG. 1, illustrated after a manufacturing step thereof;

FIG. 3b is a bottom plan view and a perspective view of the router template of FIG. 1, illustrated after another manufacturing step thereof;

FIG. 3c is a bottom plan view and a perspective view of the router template of FIG. 1, illustrated after another manufacturing step thereof;

FIG. 3d is a bottom plan view and a perspective view of the router template of FIG. 1, illustrated after yet another manufacturing step thereof;

FIG. 3e is a section view of the router template of FIG. 1 taken along section line 3e-3e from FIG. 3d;

FIG. 4 is an exploded perspective view of a router template assembly and a hand tool for use therewith, the router template assembly includes the router template of FIG. 1;

FIG. 5 is a perspective view of the router template of FIG. 1, illustrated in cooperation with a router table and providing an overview of steps involved in a cutting operation associated therewith;

FIG. 6 is a perspective view of the router template and router table of FIG. 5, illustrated in a setup process thereof;

FIG. 6a is an enlarged fragmentary side elevation view of a router bit of the router table in FIG. 6, illustrated in cooperation with the router template in FIG. 6, taken along the view arrow 6a in FIG. 6;

FIG. 7 is a perspective view of the router template and router table of FIG. 5, illustrated in a step of the cutting operation;

FIG. 8a is a top plan view of the router template and router table of FIG. 5 illustrated during the cutting operation;

FIG. 8b is a top plan view of the router template and router table of FIG. 5, illustrated during the cutting operation;

FIG. 8c is a top plan view of the router template and router table of FIG. 5, illustrated during the cutting operation;

FIG. 9 is a partial section side view of the router template and router table of FIG. 5, illustrated during the cutting operation;

FIG. 10 is a perspective view of the router template of FIG. 1, illustrated in cooperation with the hand tool of FIG. 4, during an ejection process of the tile and associated scrap pieces;

FIG. 11 is a perspective view of the router template of FIG. 1 illustrated in cooperation with the hand tool of FIG. 4, illustrating another ejection process of the tile and the scrap pieces;

FIG. 12 is a perspective view of a tile pattern created from the router template of FIG. 1;

FIG. 13 is a perspective view of an alternative embodiment die punch in accordance with the teachings of the present invention, illustrated with a workpiece and an associated tile;

FIG. 14 is an enlarged perspective view of the die punch and tile of FIG. 13;

FIG. 15a is a side partial section view of the die punch of FIG. 13, illustrated during a punching operation thereof;

FIG. 15b is another side partial section view of the die punch of FIG. 13, illustrated during the punching operation thereof;

FIG. 15c, is yet another side partial section view of the die punch of FIG. 13, illustrated during the punching operation thereof;

FIG. 16 is a top plan view of the die punch of FIG. 13, illustrated in cooperation with a router table, which utilizes a router bit in accordance with the teachings of the present invention;

FIG. 17 is a partial section side view of the die punch and router table of FIG. 16, the partial section being taken along section line 17-17 in FIG. 16;

FIG. 18 is a perspective view of an alternative embodiment template in accordance with the teachings of the present invention, illustrated with a tile and a workpiece;

FIG. 19a is a perspective view of a plurality of tile patterns, each assembled from tiles fabricated from the router template of FIG. 1;

FIG. 19b is a perspective view of a plurality of assembly jigs in accordance with the teachings of the present invention, utilized in assembly of the tile patterns of FIG. 19a;

FIG. 19c is a perspective view of a plurality of assembly plates in accordance with the teachings of the present invention, utilized with the patterns of FIG. 19a and the assembly jigs of FIG. 19b;

FIG. 19d is a perspective view of the tile patterns of FIG. 19a in cooperation with the assembly jigs of FIG. 19b;

FIG. 19e is a perspective view of a plurality of assemblies, provided by the tile patterns of FIG. 19a and the assembly plates of FIG. 19c;

FIG. 20 is an exploded perspective view of an assembly jig of FIG. 19b and an assembly plate of FIG. 19c;

FIG. 21 is a partially exploded perspective view of an assembly jig of FIG. 19b, an assembly plate of FIG. 19c and a tile pattern of FIG. 19a;

FIG. 22 is an enlarged perspective view of one of the assembly jigs of FIG. 19d, illustrated with a tile pattern of FIG. 19a assembled therein;

FIG. 23 is an exploded perspective view of the assembly jig and pattern assembly of FIG. 22;

FIG. 24 is a perspective view of one of the tile patterns of FIG. 19a, illustrated with an alternative embodiment assembly plate in accordance with the teachings of the present invention;

FIG. 25 is a perspective view of a piece of furniture incorporating a tile pattern in accordance with the teachings of the present invention;

FIG. 26 is a perspective view of another piece of furniture incorporating a tile pattern in accordance with the teachings of the present invention;

FIG. 27 is a perspective view of a staircase incorporating a tile pattern in accordance with the teachings of the present invention;

FIG. 28 is a perspective view of an inlay template in accordance with the teachings of the present invention;

FIG. 29 is a top plan view of the inlay template of FIG. 28;

FIG. 30 is a partial section view of the inlay template of FIG. 28 taken along section line 30-30 in FIG. 29, illustrated in cooperation with a workpiece and a router;

FIG. 31 is an exploded view of the inlay template, workpiece and router of FIG. 30;

FIG. 32 is a perspective view illustrating the inlay template, workpiece and router of FIG. 30 during a cutting operation;

FIG. 33 is a perspective view of the inlay template, workpiece and router of FIG. 30 also during the cutting operation;

FIG. 34 is a perspective view of the inlay template, workpiece and router of FIG. 30 during the cutting operation;

FIG. 35 is a perspective view of the inlay template and workpiece of FIG. 30 illustrating an intermediate setup step during the cutting operation;

FIG. 36 is a perspective view of the inlay template and workpiece of FIG. 30, illustrating another intermediate setup step during the cutting operation;

FIG. 37 is a perspective view of the inlay template, workpiece and router of FIG. 30, illustrating yet another intermediate setup step of the cutting operation;

FIG. 38 is a perspective view of the inlay template, workpiece and router of FIG. 30, illustrated during the cutting operation;

FIG. 39 is a perspective view of the workpiece of FIG. 30, after the cutting operation;

FIG. 40 is another perspective view of the workpiece of FIG. 30 after the cutting operation;

FIG. 41 is yet another perspective view of the workpiece of FIG. 30, illustrated after the cutting operation;

FIG. 42 is a top plan view of the workpiece of FIG. 41;

FIG. 43 is an enlarged fragmentary top plan view of the workpiece of FIG. 42;

FIG. 43a is an enlarged fragmentary view of the workpiece of FIG. 43;

FIG. 44 is a perspective view of a punch in accordance with the teachings of the present invention, illustrated in cooperation with the workpiece of FIG. 41;

FIG. 45 is a side plan view of the punch and workpiece of FIG. 44;

FIG. 46 is an enlarged perspective view of a punch body of the punch of FIG. 44;

FIG. 47 is an enlarged perspective view of a punch shaft of the punch of FIG. 44;

FIG. 48 is a perspective view of a border template in accordance with the teachings of the present invention, the border template is illustrated in cooperation with a workpiece and a finished border piece, which is also illustrated in cooperation with a tile pattern of FIG. 19a;

FIG. 49 is an exploded perspective view of the border template and workpiece of FIG. 48;

FIG. 50 is a partially exploded section view of the border template and workpiece taken along section line 50-50 in FIG. 49;

FIG. 50a is a section view of the border template and workpiece taken along section line 50-50 in FIG. 49;

FIG. 51 is a perspective view of the border template and workpiece of FIG. 48 illustrated in cooperation with a table and a router;

FIG. 52 is an enlarged partial section side view of the border template, workpiece, table and router of FIG. 51 during a cutting operation;

FIG. 53 is a perspective view of the border template and workpiece of FIG. 48 illustrated in cooperation with a router table;

FIG. 54 is a side elevation view of the border template, workpiece and router table of FIG. 53, illustrated during a cutting operation;

FIGS. 55a-55f are top plan views of a geometry associated with steps of generating the router template of FIG. 1, and associated with steps of generating a tessellation, a spline tessellation, a tile pattern, a tessellated tile pattern and a router template;

FIGS. 56a-56c are top plan views of a geometry associated with steps of generating the router template of FIG. 1, and associated with steps of generating a tessellation, a spline tessellation, a tile pattern, a tessellated tile pattern and a router template;

FIG. 57 is a top plan view of a geometry, utilized in a step of generating a tessellation, a spline tessellation, a tile pattern, a tessellated tile pattern and a router template;

FIG. 58 is a top plan view of a geometry during a step of generating a tessellation, a spline tessellation, a tile pattern, a tessellated tile pattern and a router template, and FIG. 58 is also a top plan view of a deformation tessellated tile pattern;

FIG. 59 is a top plan view of tile patterns of FIG. 19a and the tile of FIG. 1;

FIG. 60 is a top plan view of a tile and tile patterns in accordance with the teachings of the present invention;

FIG. 61 is a top plan view of another tile and tile patterns in accordance with the teachings of the present invention;

FIG. 62 is a top plan view of tiles and a tile pattern in accordance with the teachings of the present invention;

FIG. 63 is a perspective view of the tile of FIG. 60, a router template, a workpiece, and scrap pieces;

FIG. 64 is a partial section perspective view of a punch in accordance with the teachings of the present invention illustrated in cooperation with the tile of FIG. 63;

FIG. 65 is another partial section perspective view of the punch and tile of FIG. 64;

FIG. 66 is a perspective view of the tile pattern of FIG. 60;

FIG. 67 is a perspective view of the tile of FIG. 61, a router template, a workpiece and scrap pieces;

FIG. 68 is a perspective view of the tile pattern of FIG. 61;

FIG. 69 is a perspective view of a tile pattern fabricated from the tiles of FIGS. 60 and 61;

FIG. 70 is a perspective view of the tiles of FIG. 62, illustrated with router templates, workpieces and scrap pieces;

FIG. 71 is a perspective view of the tile pattern of FIG. 62;

FIGS. 72a and 72b illustrate geometries during steps of generating a tessellation, a spline tessellation, a tile pattern, a tessellated tile pattern and a router template;

FIG. 73 is an enlarged top plan view of a facet of the geometry in FIG. 72b illustrated in combination with a splined profile;

FIG. 74a illustrates the geometry of FIG. 72b converted into the spline profiles of FIG. 73, and a tile pattern, tessellation, tessellated tile pattern and a step for fabricating a router template;

FIG. 74b illustrates another view of the geometry of FIG. 74a, oriented in a position similar to that of FIG. 72a, and a tile pattern, a tessellation, a tessellated tile pattern and a step for fabricating a router template;

FIG. 75 is a perspective view of an alternative embodiment table top in accordance with the teachings of the present invention;

FIG. 76 is an exploded perspective view of the table top of FIG. 75;

FIG. 77 is a perspective view of a jig in accordance with the teachings of the present invention illustrated in cooperation with a piece of the table top of FIG. 75, and in cooperation with a router table;

FIG. 78 is a front elevation view of the jig and router table of FIG. 77;

FIG. 79 is a top plan view of the jig and router table of FIG. 77;

FIG. 80 is a perspective view of the jig and router table of FIG. 77, illustrated in cooperation with a workpiece;

FIG. 81 is a flowchart illustrating steps associated with generating patterns and apparatuses in accordance with the teachings of the present invention;

FIG. 82 is a top plan view of a workpiece illustrated in combination with the inlay template of FIG. 28;

FIG. 83 is a perspective view of the workpiece and template of FIG. 82;

FIG. 84a is a partial section perspective view of a spring-loaded retaining pin in accordance with the teachings of the present invention, illustrating the pin in a retracted position;

FIG. 84b illustrates the spring-loaded retaining pin of FIG. 84a in an extended position;

FIG. 85a is a partial section perspective view of a spring-loaded ejection pin in accordance with the teachings of the present invention, illustrating the pin in a retracted position; and

FIG. 85b illustrates the spring-loaded ejection pin of FIG. 85a in an extended position.

### DETAILED DESCRIPTION OF THE PREFERRED EMBODIMENT(S)

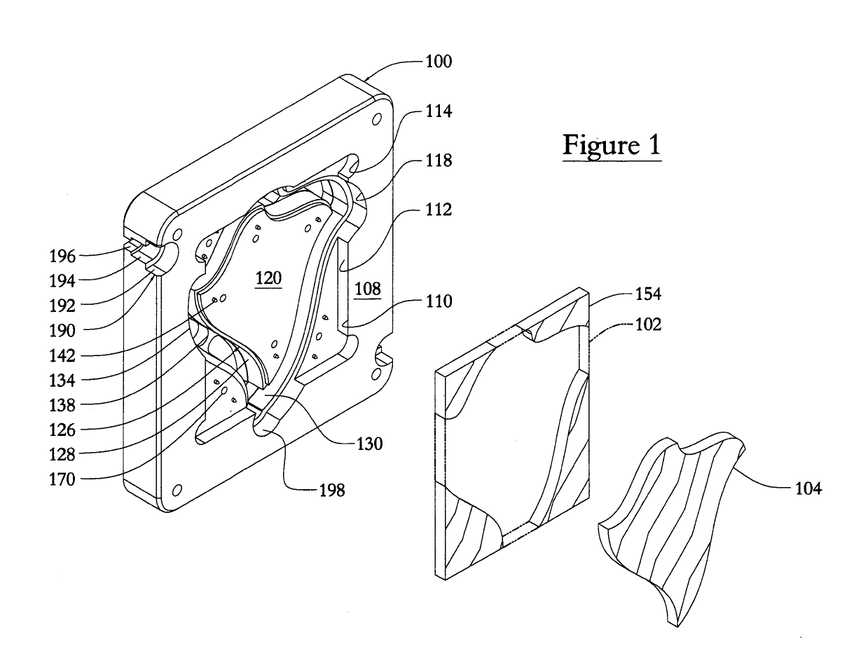

With reference to FIGS. 1 to 4, a preferred embodiment jig is illustrated in accordance with the teachings of the present invention. The jig is embodied as a router template and is referenced generally by numeral 100. The template 100 utilized for receiving and retaining a workpiece 102, which is illustrated in phantom in FIG. 1. The template 100 is adapted to cooperate with a conventional router table for routing the workpiece 102 for fabricating a finished tile 104. A wooden workpiece 102 is illustrated, however, the invention contemplates any tile material such as ceramic, stone, polymer, composite, formica or the like. The template 100 enables a novice woodworker, with minimal tools, to create precision geometric or tessellated patterns in wood and other materials. The template 100 may be formed from a machined piece of stock, such as aluminum or steel, or machined from an aluminum, steel or alloy casting, or injection molded from a high strength plastic material. The template 100 may be coated with a low friction material, or laminated to reduce friction between the template and the router table.

The template 100 has a footprint larger than the workpiece 102 to stabilize the template 100 upon a router table, or alternatively to stabilize a manually operated router upon the template 100. This stabilization maintains a perpendicular relationship of an associated router bit with the template 100.

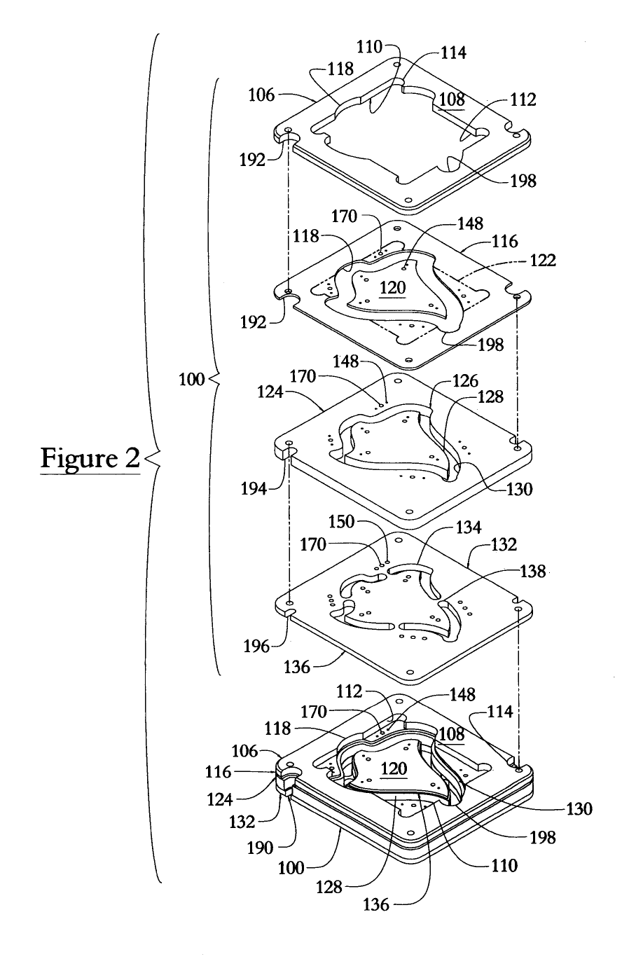

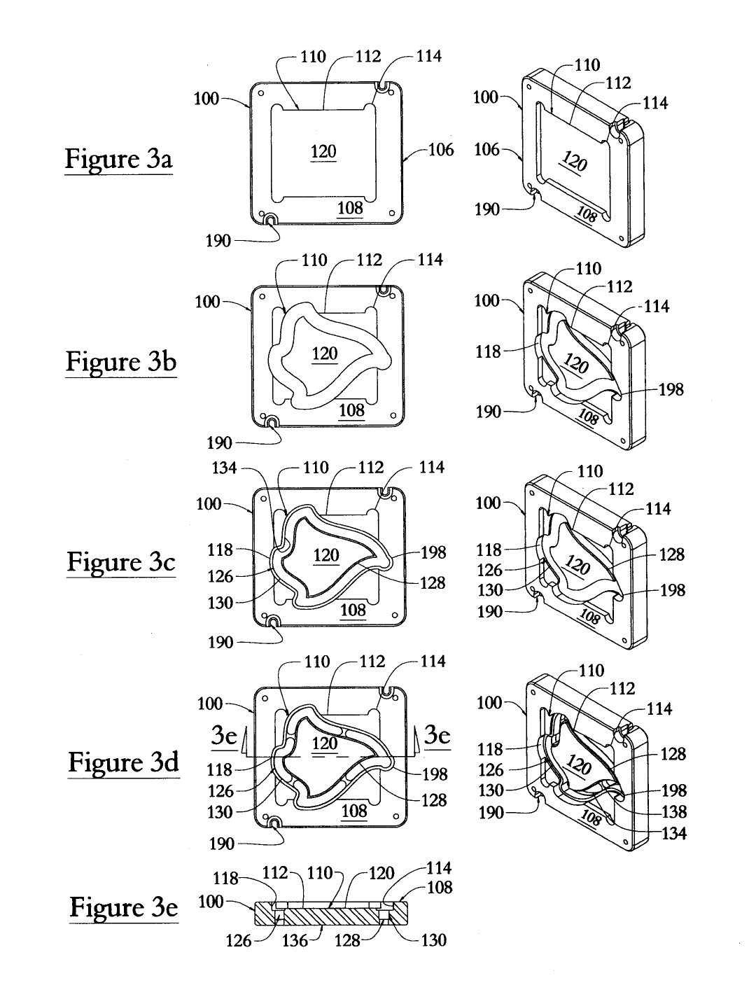

Referring specifically to FIG. 2, the template 100 is illustrated exploded into four general layers, which comprise the template 100. FIG. 2 also illustrates the template 100 with cutting lines imbued thereon representing the planes of separation illustrated in the exploded layers. The first layer 106 includes a bottom surface 108 of the template, which acts as a sliding surface for cooperating with the router table and sliding thereupon. Additionally, the bottom surface 108 may provide a support surface to a hand held router. The first layer 106 includes a base cavity 110. The base cavity 110 includes a workpiece nest 112 for retaining the workpiece lengthwise and widthwise within the template 100. Since the workpiece 102 is rectangular in shape, the workpiece nest 112 is generally rectangular in shape as well, and includes cutouts 114 at each of the corners of the workpiece 102 to provide ease and placement of the workpiece 102 within the nest 112. The nest 112 retains the workpiece 102 laterally and acts as a rough two-way locator for accepting a rough cut workpiece 102.

A second template layer 116 includes a cutter path 118 formed therein. The cutter path 118 matches the silhouette of the tile 104 and is sized to provide clearance to a router cutting bit. The cutter path 118 defines a platen 120 of the nest 112 for receiving the workpiece 102 in the direction of the stock thickness for retaining the workpiece 102 within the template 100 and maintaining the workpiece 102 flattened parallel to the bottom surface 108 of the template 100 and the associated router table or router. The platen 120 has a silhouette that is undersized relative to the finished tile 104 to provide clearance to the cutter in operation. Additionally, the cutter path 118 provides an overall clearance to the cutter to prevent a cutting edge of the router bit to contact the template 100, thereby preventing damage to the router bit, router and template 100. Additionally, the cutter path 118 allows cut debris to flow away from the associated cutter bit. The cutter path 118 is also formed through the first layer 106 and therefore forms part of the base cavity 110. Portions of the second layer 116, that are outboard of the cutter path 118 and within the nest 112, form part of the platen 120 and are illustrated within a platen perimeter 122 that is illustrated in phantom in FIG. 2.

The template 100 includes a third layer 124, which includes a bearing path 126 formed therethrough. The bearing path 126 is aligned with the cutter path 118. The bearing path 126 is a high precision slot for receiving a router bearing for guiding the template relative to the router cutting bit, or the router relative to the template 100, so that a precision router cutting operation is performed on the workpiece 102. The bearing path 126 provides minimal, exacting precision clearance for the router bearing. Since the tile 104 is oriented inboard relative to the bearing path 126, it is desired that the user maintain the router bearing against the inboard lateral portion 128 of the bearing path 126 thereby providing clearance externally above the router bit. In the alternative, if the tile 104 were oriented externally of the bearing path 126, it would be desired to maintain the routing bearing against an external lateral region 130 of the bearing path 126 while maintaining the clearance internally relative to the router bearing. This practice provides an accurate tile 104 that is cut relative to the bearing path 126. Additionally, the bearing path 126 assists in the flow of air and debris through the template 100.

The template 100 includes a fourth layer 132. The inboard bearing path region 128 and the platen 120 center extend therefrom and the outboard bearing path region 130 extends therefrom thereby providing a unitary template 100. The fourth layer 132 includes a series of slots 134 formed therethrough. The slots 134 collectively provide a window opening through the template 100, which is viewable from a top surface 136 of the template 100. The slots 134 are generally aligned with the bearing path 126 and the cutter path 118. The slots 134 do not encompass the entire perimeter of the tile 104 to provide a series of webs 138 for maintaining regions of the template 100 that are both inboard and outboard of the cutter path as the unitary apparatus. The slots 134 permit visual access to the cutter bit and the workpiece 102 during the cutting operation. The width of the slots 134 is less than the router cutter bearing diameter to restrict access of the cutter bit from the operator during operation. Additionally, the slots 134 permit flow of air and debris through the template 100. Conventional routers typically force air along the router bit thereby removing debris from the cutting operation. The template 100 collectively provides openings through the four layers 106, 116, 124 and 132 for assisting in this flow of forced air and for permitting debris removal from the cutting operation. Alternatively, the top surface 136 could be closed and attached to a vacuum system for removing and filtering debris from the cutting operation.

Of course, any number of functional layers is contemplated within the spirit and scope of the present invention. The template embodiment 100 illustrated includes preferred layers utilized in the fabrication of the tile 104.

With reference now to FIGS. 3a to 3e, manufacturing steps for the template 100 are illustrated. FIG. 3d illustrates the template 100 with all four layers 106, 116, 124 and 132, and FIG. 3e is a section view across the template 100. The following manufacturing steps refer to machining operations, which may be performed from a mill or a Computer Numerical Control (CNC) machine upon a blank stock piece, a casting or the like. Of course, the invention contemplates that each of these steps may be performed concurrently through a plastic injection molding process. In reference to the following manufacturing steps, the invention contemplates that these steps may be performed in any order, however the below description follows the flow from the first layer 106 through the fourth layer 132.

Referring now to FIG. 3a, the template 100 is provided with a flat bottom surface 108, which can be provided from a flat stock piece, or machined into a stock piece or casting.

Referring now to FIGS. 3a to 3d, the router template 100 is illustrated after incremental manufacturing steps have been performed thereto. Each of these manufacturing steps, for a preferred embodiment of the router template 100, are performed by a CNC machine Referring now to FIG. 3a, the base cavity 110 is machined into the jig thereby providing the workpiece nest 112 and cutouts 114. The base cavity 110 is cut to a depth thereby providing a platen 120 within the base cavity 110.

With reference now to FIG. 3b, a subsequent step machines the cutter path 118 into the router template 100. The cutter path 118 is cut to a depth that is deeper than that of the platen 120, which is also illustrated in FIG. 3e. The cutter path 118 intersects the base cavity 110 thereby providing the platen 120 in a shape similar to the finished workpiece 102, however having a greater overall width extending slightly inward from the finished workpiece 102.

FIG. 3c illustrates the next manufacturing step, the machining of the bearing path 126. As illustrated in FIGS. 3c and 3e, the bearing path 126 is generally aligned with the cutter clearance path 118. However, the bearing path 126 has a narrower slot width and is formed deeper in the router template 100 than the cutter path 118.

Referring now to FIGS. 3d and 3e, the next manufacturing step comprises machining of the slots 134, which collectively provide a window for viewing the cutting operation within the router template 100 from the top surface 136 of the router template 100. The slots 134 are not continuous to provide webs 138 which interconnect the platen 120 with the remainder of the router template 100. The slots 134 are formed in a depth of the router template 100 that is greater than that of the bearing path 126. The slots 134 each have a slot width that is less than that of the bearing path 126 to prevent an associated cutter from extending into the bearing path 126, in the instance that the cutter depth may be inadvertently set to an improper dimension.

Although the steps listed above are in a sequence for manufacturing the preferred router template 100, any series and sequence of steps is contemplated within the spirit and scope of the present invention.

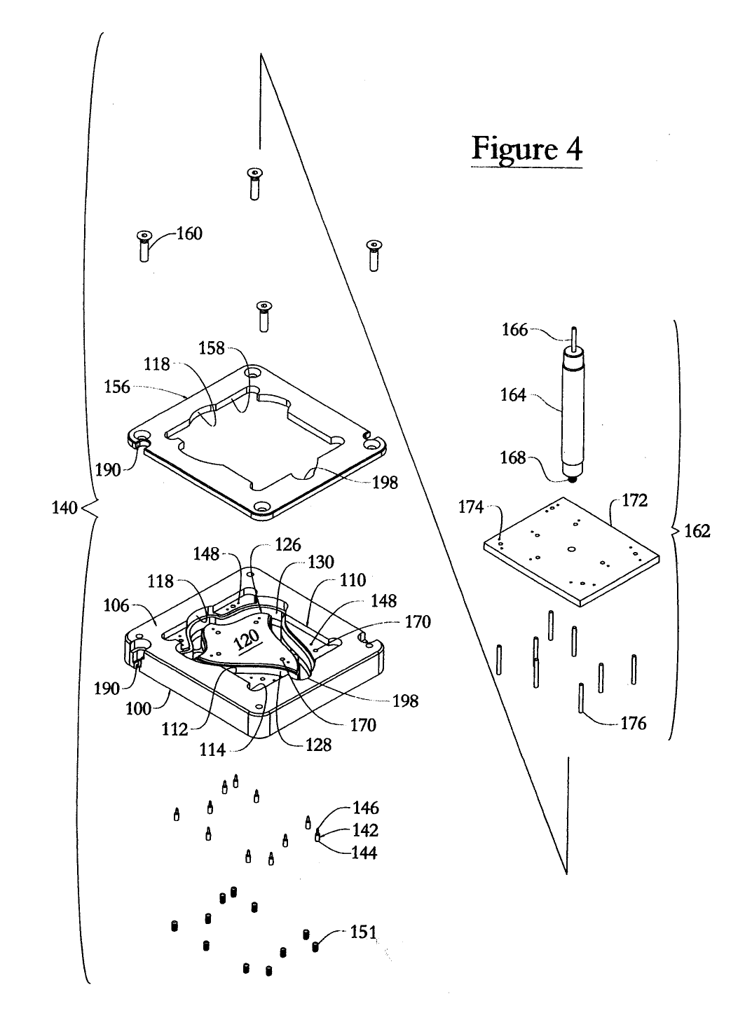

With reference now to FIG. 4, a router template assembly 140 is illustrated in accordance with the teachings of the present invention. The router template assembly 140 includes the router template 100. The router template 100 includes a retaining mechanism for retaining the workpiece 102, and subsequently the tile 104, within the workpiece nest 112 during the cutting operation. The retaining mechanism of a preferred embodiment router template 100 is a plurality of retaining pins 142 for rigid and precise two-way locating. The retaining pins 142 assure two-way location and minimize displacement during router operation. The retaining pins 142 allow a workpiece 102 to be reinserted into the template 100 if required.

To maintain finite accuracy two operations could be performed, a rough cutting operation, and a finish cutting operation. The advantage to this process is to optimize cutter performance. An old worn cutter bit can be used for rough operation to cut the basic shape. A new sharp cutter bit can be used to cut the pattern to ensure dimension stability between parts and lengthen cutter life, since only minimal material will be cut. The invention contemplates router templates that are used for cutting basic non-tessellated shapes and holes, which utilize brad nails that are hammered in from the top of the template through a non precision access hole in the template to hold the workpiece during operation.

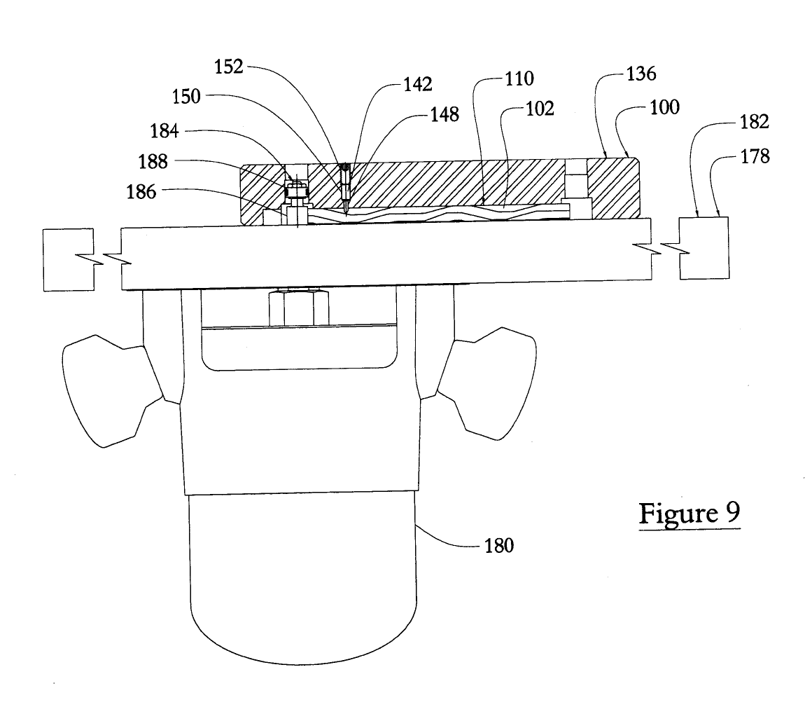

With reference to FIG. 4 and FIG. 9, each retaining pin 142 includes a body portion 144 and a pin end 146 that is narrower than the body 144 and extends therefrom. Each pin end 146 extends through an aperture 148 formed through the platen 120. Each pin body 144 is received within an enlarged pin body bore 150, which is enlarged relative to the pin aperture 148 and is coaxially aligned therewith for receiving the pin body 144. A series of set screws 151 are each received within a threaded region 152 coaxially aligned with the bore 150 for securing the retaining pins 142 within the router template 100.

Referring again, specifically to FIG. 4, the retaining pins 142 are assembled into the router template 100 to extend into the base cavity 110. When a workpiece 102 is introduced into the workpiece nest 112, the pins 142 pierce the underside of the workpiece 102 and retain the workpiece 102 and subsequently the tile 104 and associated scrap pieces 154 during the cutting operation.

Each retaining pin 142 is formed of a tool steel that is hardened subsequent to machining The hardening process is preferably performed by cryogenically freezing the pins 142. The retaining pins 142 are removable from the router template 100 for replacement due to wear or fatigue. Although retaining pins 142 are illustrated and described, any retaining mechanism is contemplated within the spirit and scope of the present invention. For example, the workpiece 102 could be retained by a vacuum, an adhesive or the like.

With reference again to FIG. 4, the router template assembly 140 is illustrated with an optional spacer 156. The workpiece nest 112 includes a nominal depth for a nominal thickness workpiece 102; for example one-quarter inch stock. The spacer 156 includes an aperture 158 formed therethrough having a matching profile with the workpiece nest 112. The spacer 156 is fastened to the router template 100 by a plurality of fasteners 160. The spacer 156 has a nominal thickness for permitting use of the router template assembly 140 with a workpiece 102 having a thickness greater than that of the workpiece nest 112. For example, spacer 156 could have a thickness of one quarter inch for utilization with half inch stock. Of course, the invention contemplates that the router template assembly 140 may be provided with a series of spacers 156, each having an incrementally increasing thickness for utilization of the assembly 140 with a plurality of workpiece 102 thicknesses. For example, an optional spacer could be provided for three quarter inch stock and one inch stock as well.

Referring to FIG. 4, a multi-purpose hand tool 162 is illustrated for utilization with the router template assembly 140. The hand tool 162 includes a handle 164 with an ejection pin 166 extending from one end and a threaded rod 168 extending from the other end. A user may grasp the handle 164 and utilize the hand tool 162 for inserting the ejection pin 166 into one of a series of ejection bores 170 that are formed through the platen 120 of the router template 100, generally approximate to one of the pin apertures 148. Each pin end 146 has a length less than the thickness of the associated workpiece 102 to avoid burrs or imperfections imparted upon the front or finished surface of the resulting tile 104. Subsequent to the woodworking operation, the resulting tile 104 and scrap pieces 154 are retained within the workpiece nest 112 due to the cooperation with the retaining pins 142. Therefore, the user may eject the tile 104 and scrap pieces 154 by inserting the ejection pin 166 into each ejection bore 170 from the top surface 136 to thereby remove these pieces from the router template 100.

The hand tool 162 includes a gauge plate 172 threadably connected to the threaded rod 168. The gauge plate 172 has a length, width and thickness that matches the workpiece 102 for utilization as a gauge that can be used with other power tools, such as a table saw for cutting stock into workpieces 102 sized for the router template 100.

The gauge plate 172 includes a plurality of pin straightening apertures 174 each formed to the gauge plate 172. The pin straightening apertures 174 are counter-sunk on the bottom surface (not shown). When the retaining pins 142 experience wear to an extent wherein pin ends 146 become bent, the gauge plate 172 may be inserted into the workpiece nest 112 as illustrated in the guiding lines in FIG. 4 so that each pin end 146 is inserted into a corresponding pin straightening apertures 174 thereby realigning any misaligned pin ends 146. Of course, the retaining pins 142 are hardened to an optimal hardness to ensure long life and minimal deflection during operation.

The hand tool 162 includes a plurality of ejection pins 176 each affixed to and extending from the gauge plate 172. The ejection pins 176 are arranged so that the user may grasp the handle 164 and insert the ejection pins 176 into the ejection bores 170 to eject the tile 104 and scrap pieces 154 in one ejection motion. If a workpiece material is selected that is not easily insertable into the workpiece nest 112, due to interference with the retaining pins 142, or is not easily removable via ejection from the workpiece nest 112, a user may utilize a mallet or the like for inserting the workpiece 102 into the workpiece nest 112 and for ejecting the workpiece 102 from the workpiece nest 112. The arrangement of the ejection pins 176 is symmetrical so that the ejection pins 176 are received into the ejection bores 170 when the gauge plate 172 is being utilized for straightening the retaining pins 142.

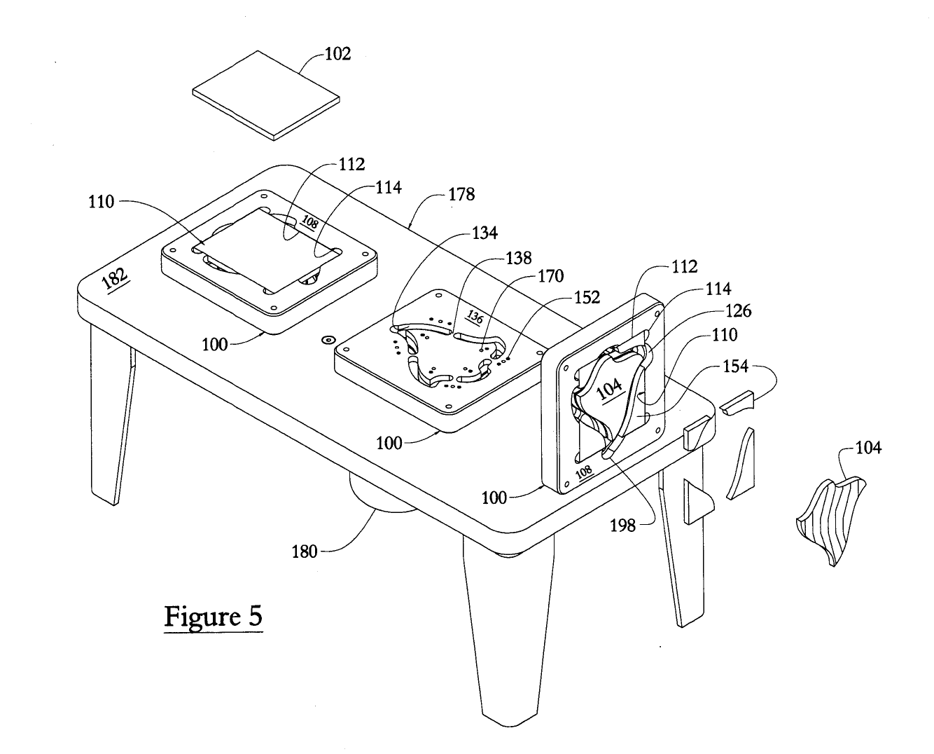

With reference now to FIG. 5, a brief overview of the cutting process is illustrated. Specifically, a conventional router table 178 is illustrated including a conventional router 180 affixed underneath a table surface 182 of the router table 178. A router bit or cutter can be mounted in the router 180 for extending through the table surface 182 for performing the cutting operation.

Initially, a workpiece 102 is provided that is cut to the dimensions of the workpiece nest 112. The gauge plate 172 may be utilized for assisting and providing the workpiece 102 or a plurality of workpieces 102. Subsequently, the workpiece 102 is inserted into the workpiece nest 112. A mallet may be utilized for pressing the workpiece 102 upon the retaining pins 142. The router template bottom surface 108 is subsequently placed upon the table surface 182 for engagement of the router bit with the workpiece 102 within the router template 100. The user may view the woodworking operation through the slots 134. Subsequently, a finished tile 104 and scrap pieces 154 are generated from the workpiece 102 from the woodworking operation. The tile 104 and scrap pieces 154 are then ejected from the router template 100.

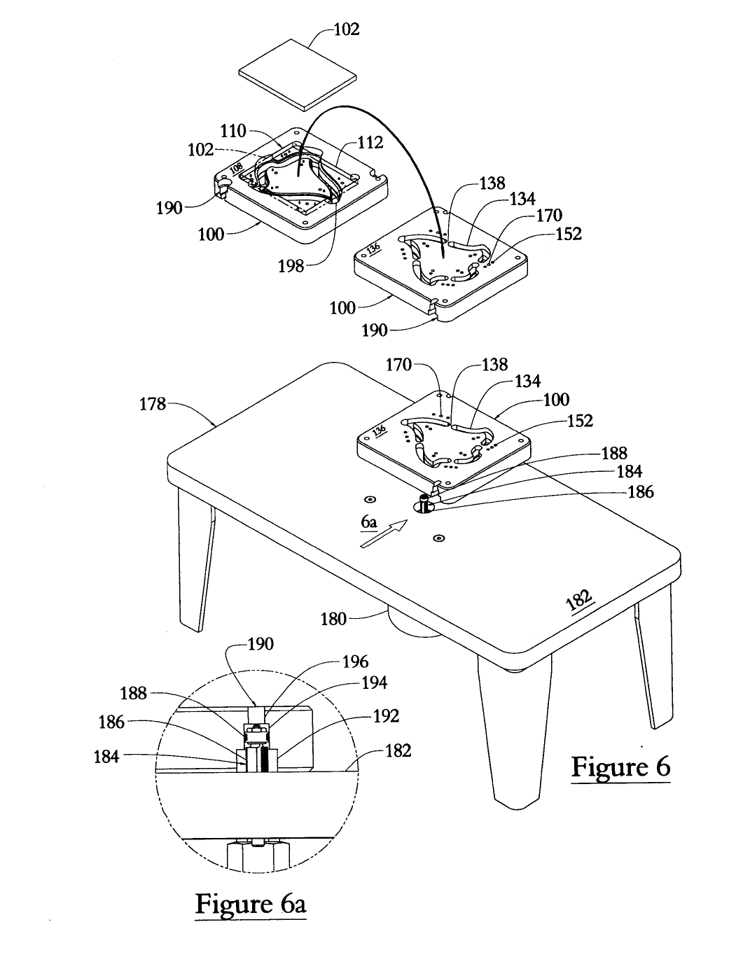

Referring now to FIG. 6, setup of the router template 100 and router table 178 is illustrated and described. The router table 178 is illustrated with a router bit 184 extending through the table surface 182 from the router 180. Referring to FIG. 6a, the router bit 184 includes fluted side cutter 186 with a guide bearing 188 fastened at a distal end thereof.

Referring to FIGS. 6 and 6a, the router template 100 includes a router bit setup gauge 190 formed on a lateral side. Specifically, the router template 100 includes a pair of router bit setup gauges 190. Each router bit setup gauge includes a cutter path region 192, a bearing path region 194 and a window slot region 196. Each cutter path region 192, bearing path region 194 and window slot region 196 have a width and height sized to represent the respective cutter path 118, bearing path 126 and window slots 134. The setup gauge 190 permits the user to view the height of the router bit 184 for adjusting the height and aligning the guide bearing 188 within the bearing path region 194 and subsequently the bearing path 126. Concurrently, it permits the user to view and adjust the height of the side cutter 186 relative to the cutter path region 192 and respective cutter path 118.

Referring again to FIG. 6, the workpiece 102 is inserted into the router template 100 and the router template is oriented so that the bottom surface 108 will engage the table surface 182.

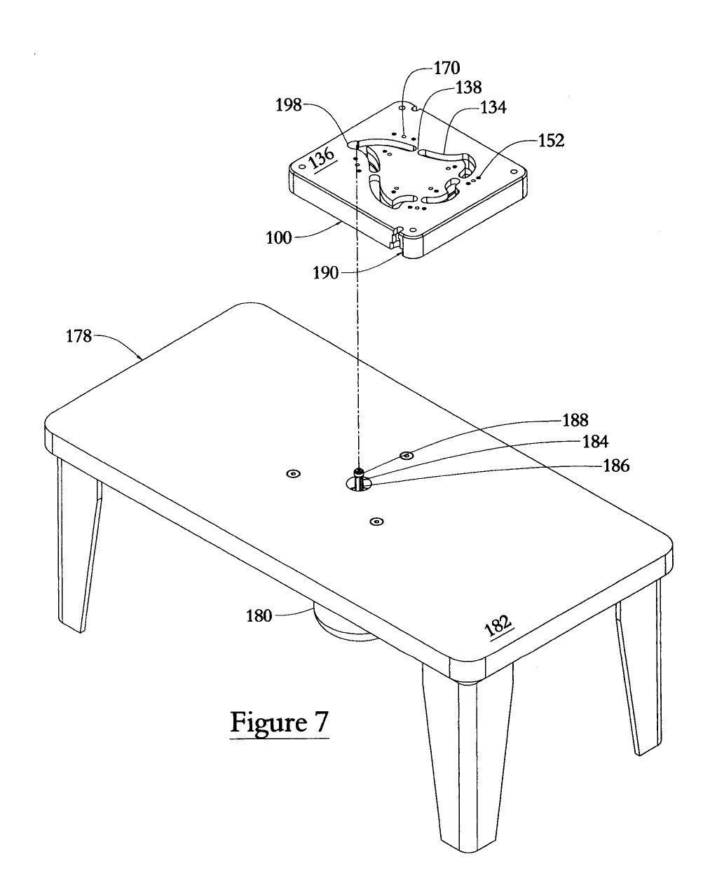

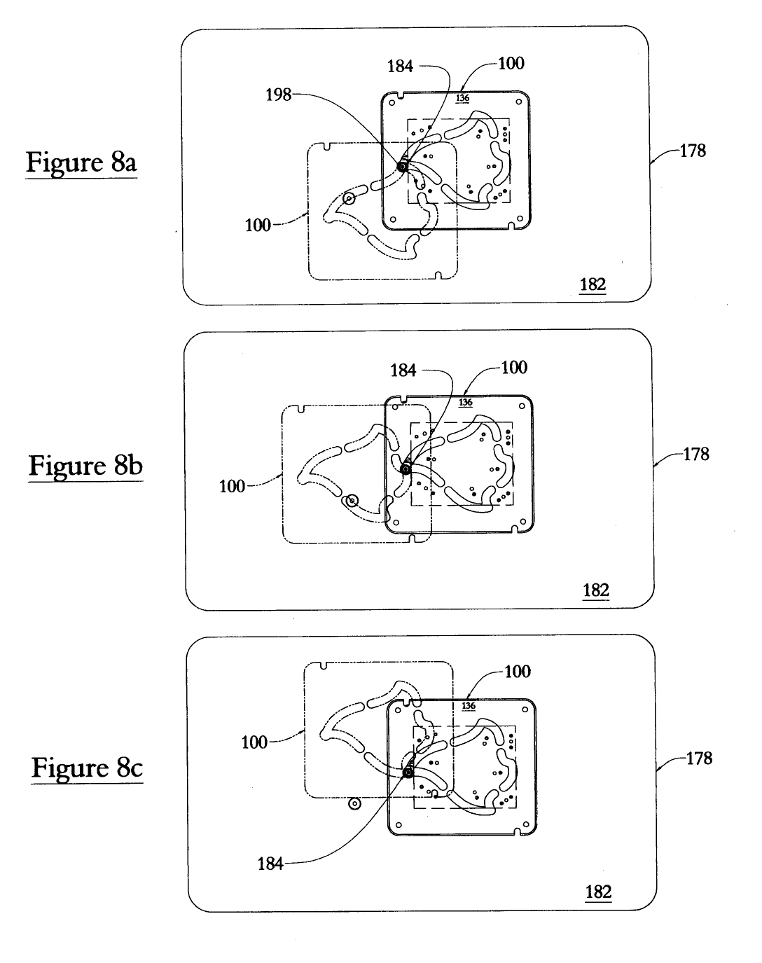

Referring now to FIGS. 7 and 8a, a starting region 198 of the cutter path 118 and bearing path 126 is aligned with the router bit 184; and the router template 100 is placed upon the table surface 182 with the router bit 184 received within the starting region 198. The starting region 198 is oriented outside the perimeter of the workpiece 102 for a startup position of the cutting operation. Upon placement of the router template 100 on the table surface 182 at the starting position illustrated in FIG. 8a, the router may be turned on thereby providing a high speed rotation to the router bit.

Subsequently, the user guides the router template 100 so that the guide bearing 188 engages the bearing path 126 at the inboard bearing path region 128 and follows the path around its perimeter as the side cutter 186 cuts the tile 104. For example, the user guides the router template 100 from the starting position, illustrated in solid in FIG. 8a, to a subsequent lateral peak of the tile 104 as illustrated in the router template 100 position in phantom in FIG. 8a. Then, the user translates the router template 100 upon the table surface 182 to a peak that longitudinally opposes the starting point, as illustrated in phantom in FIG. 8b. Subsequently, the user guides the router template 100 to another lateral peak as illustrated in FIG. 8c; and finally the user translates the router template 100 back to the starting position as illustrated in solid in FIGS. 8a to 8c.

FIG. 9 partially illustrates a side elevation view of the router table 178 in cooperation with the router template 100, which is illustrated in section view during the cutting operation. The user may guide the router template 100 manually by hand by grasping the router template 100. Alternatively, handles may be affixed to the router template 100 to assist guiding of the router template 100 during the cutting operation. The window slots 134 are sized and the webs 138 are oriented such that the scrap pieces 154 may not exit through the window slots 134 to avoid inadvertent ejection of the scrap pieces 154 or the workpiece 102 or the finished tile 104. A transparent cover (not shown) can be added to eliminate inadvertent ejection of small scrap pieces and assist in increasing vacuum capacity.

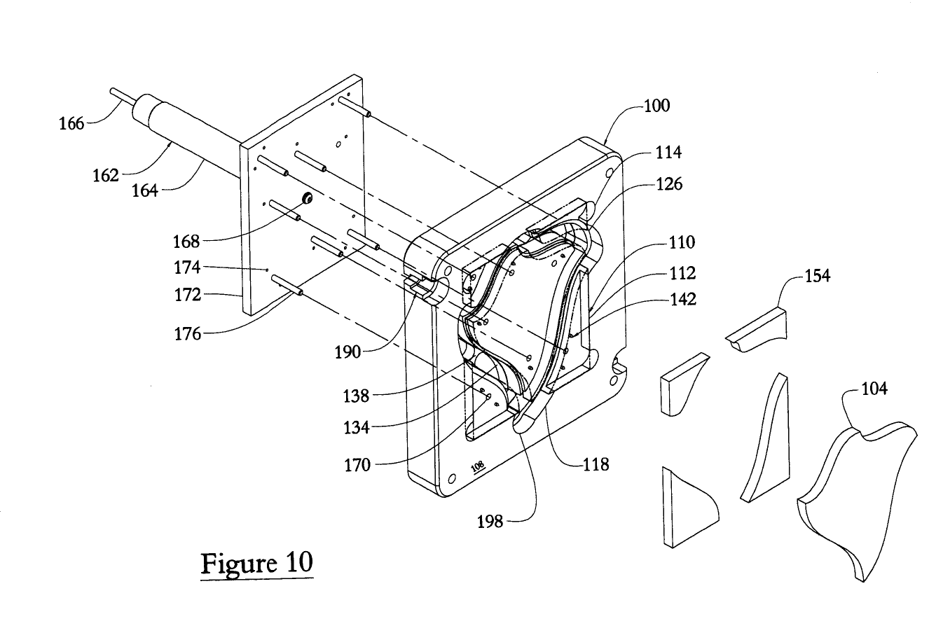

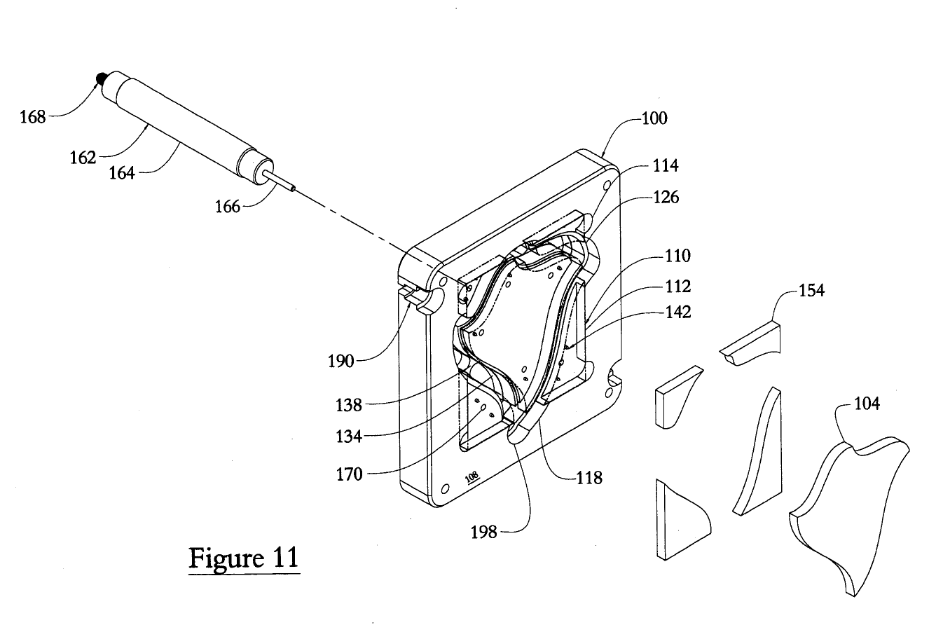

Upon completion of the cutting process, the finished tile 104 and the scrap pieces 154 are ejected from the router template 100. Referring to FIG. 10, the hand tool 162 is illustrated ejecting the tile 104 and scrap pieces 154 in one ejection motion by utilizing the ejection pins 176 extending from the gauge plate 172. Alternatively, the tile 104 and scrap pieces 154 may be ejected individually by use of the ejection pin 166 of the hand tool 162 as illustrated in FIG. 11. Manually actuated, spring-return ejection pins can be built into the template housing eliminating external ejection tools.

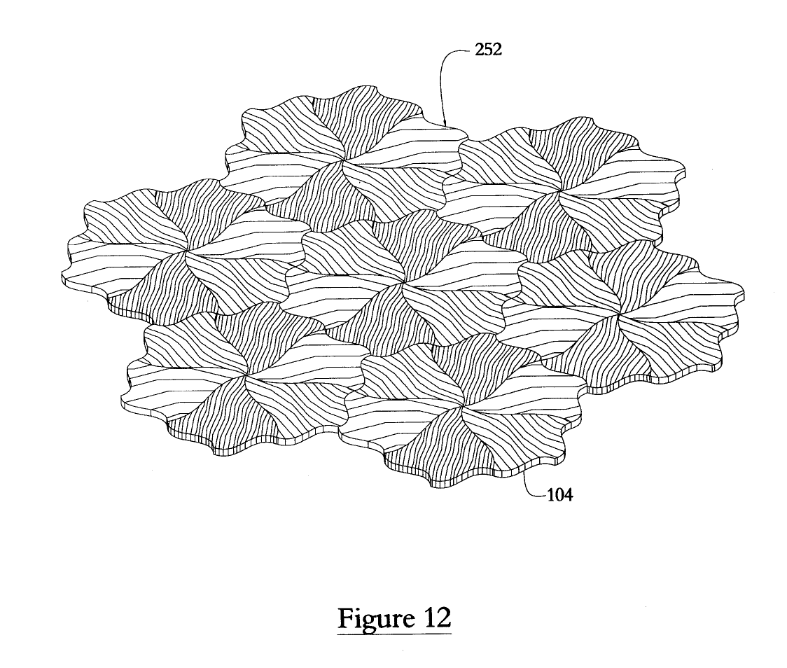

The tile 104 is a component in a tessellation. This tessellation is illustrated as a finite tessellation in FIG. 12. The tessellation is a single component tessellation where the pattern may be assembled from a plurality of tiles 104, collectively requiring only one tile shape. Accordingly, the tiles 104 may be cut from various woods or various grains to add to the aesthetic effect of the tessellation. Additionally, the tiles 104 may be stained or colored otherwise by various colors or shades to enhance the aesthetic effect. The router template 100 produces tiles 104 that are accurate and repeatable such that when assembled, as illustrated in FIG. 12, that gaps between adjacent tiles 104 are minimal or visually undetectable thereby eliminating a tedious requirement of filling the gaps as required in many prior art tile patterns and methods.

The router template bearing path 126 is a precision spline that is machined to exacting machine tool tolerances (plus or minus 0.0002 inches) and provides a nearly net repeatable shape, which is smaller than a human can see or feel. Given the tolerance play in commercial router bearings and the expansion and contraction of cutting media such as wood, a resultant tile gap tolerance of 0.001 repeatability is obtained between consecutively cut pieces. This 0.001 tolerance allows an average woodworker to assemble a pattern with no noticeable gaps between tiles during assembly. Once the tiles are secured to a stable engineered plate and sealed top and bottom, the thin pattern thickness, and relative contiguous exacting position relative to one another minimizes the effects of expansion and contraction, much greater than conventional methods. The methods for assembly fall into a new category of precision engineered laminates. They are more stable than solid woods and more precise than engineered laminate methods used conventionally.

A user can butt two pieces of straight planed boards together and get an excellent mating surface. But to create a free form shape using conventional woodworking tools, (such as a CNC router built for wood) it is difficult to mate the tessellation with a precision contiguous edge.

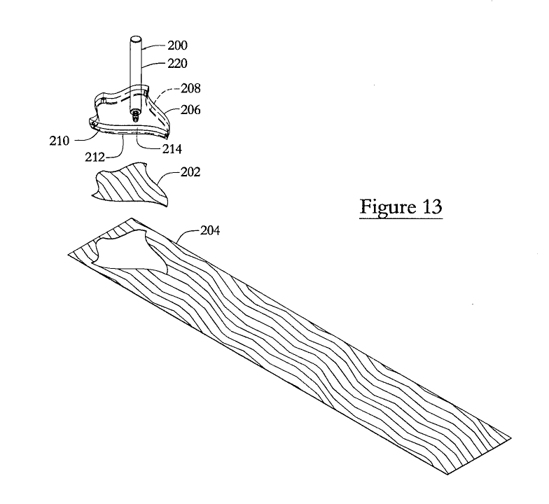

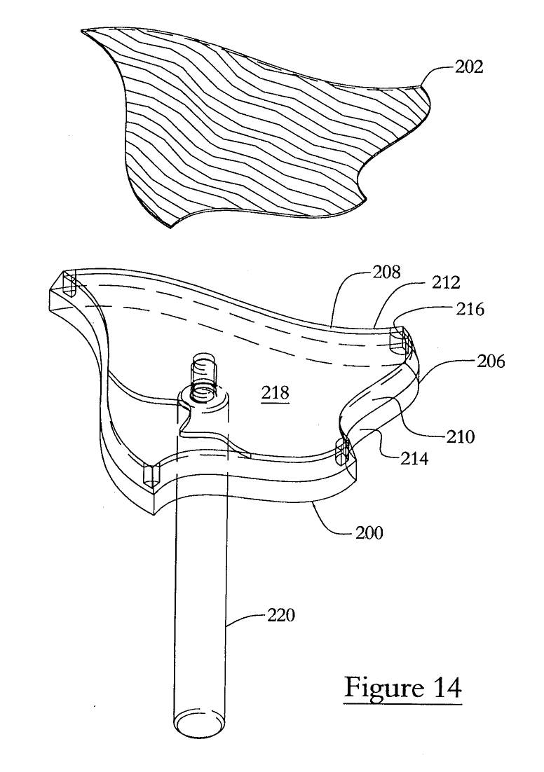

With reference now to FIGS. 13 and 14, an alternative embodiment jig is illustrated for fabricating tiles in accordance with the teachings of the present invention. Specifically, a die punch 200 is illustrated for punching a veneer tile 202 from a sheet of veneer 204. The die punch 200 includes a template 206 that is generally in the shape of the finished tile 202. Specifically, the template 206 includes a recess 208 formed therein. An inclined peripheral surface 210 is formed about the template 206. The inclined peripheral surface 210 intersects with the recess 208 thereby providing a cutting edge 212 that forms the profile of the tile 202. The template 206 also includes an external bearing path 214 for redressing the cutting edge 212.

The template 206 may be fabricated from a unitary stock piece that is machined. The template is formed from tool steel and is cryogenically hardened after machining for a long tool life. Accordingly, the recess 208 includes relief notches 216, each provided at one of the interior corners defined within the profile of the recess 208. The relief notches 216 may be formed from a machining process such as EDM (Electrical-Discharge Machining) for providing precision interior corners within the profile of the recess 208. A resilient pad 218 is provided within the recess 208 to facilitate ejection of the tile 202.

The die punch 200 includes a striker handle 220 for manual use of the die punch 200, which may be struck by a hammer or mallet to perform the punching operation. Alternatively, the template 206 may be mounted to a press.

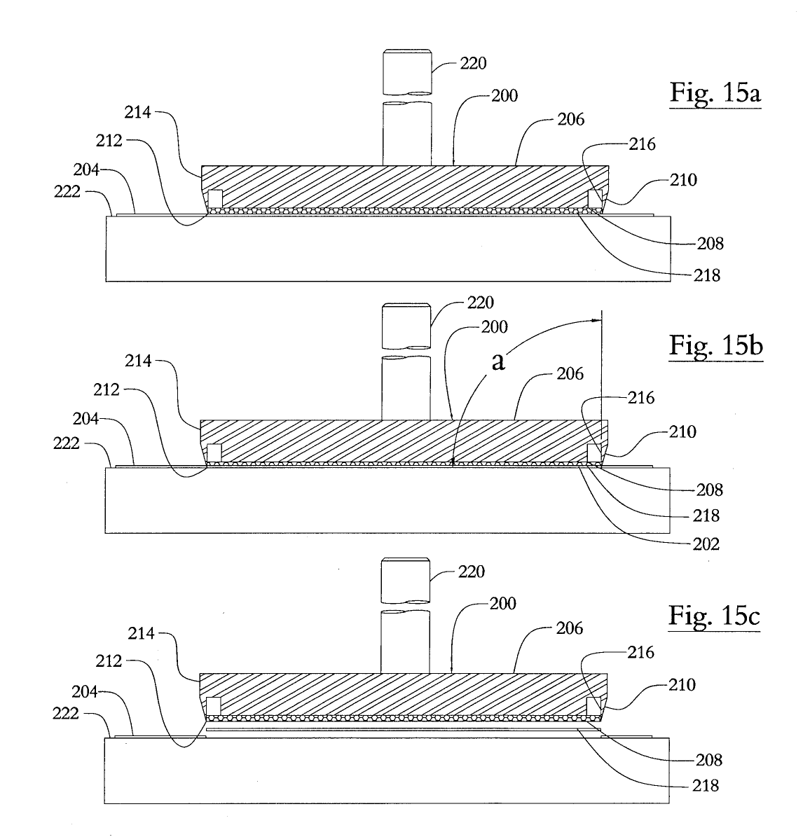

Referring now to FIGS. 15a through 15c, the punching operation is illustrated. Initially, the veneer 204 is placed upon an underlying support surface 222, such as wood or high density rubber, that will not damage the cutting edge 212. The template 206 is placed upon the veneer 204, with the recess 208 facing the veneer 204. Referring to FIG. 15b, the die punch 200 is translated towards the underlying support surface 222, such that the cutting edge 212 cuts the veneer, thereby resulting in a tile 202 that is received in the recess 208. During the striking operation, the resilient pad 218 is compressed as the tile 202 is received within the recess 208. With reference now to FIG. 15c, as the die punch 200 is removed from the underlying support surface 222, the resilient pad 218 extends to an unbiased orientation thereby ejecting the finished tile 202.

The recess 208 is formed within the template 206 at an angle indicated by ‘a’, which is generally perpendicular to the surface that includes the cutting edge 212 to thereby provide a ninety degree shear to the outward peripheral surface of the tile 202 so that many tiles 202 may be assembled together.

Referring now to FIGS. 16 and 17, the die punch 200 is illustrated in cooperation with a router table 224. The router table 224 includes a router (not shown) mounted underneath for rotating a router bit 226 within the teachings of the present invention. The router bit 226 includes a guide bearing 228 and an angled edge grinder 230. The router bit 226 is utilized for redressing the cutting edge 212 of the template 206. As the router bit is rotating, the user may guide the bearing path 214 along the guide bearing 228 as the edge grinder follows the profile of the inclined peripheral surface 210. During this operation, the edge grinder 230 sharpens and recalibrates the cutting edge 212 thereby prolonging the life of the die punch 200.

With reference now to FIG. 18, an alternative embodiment template is illustrated for fabricating tiles within the teachings of the present invention. The template is a tracing template 232 that includes a tracing plate 234 and a handle 236. The tracing plate 234 is made from a tool steel and is hardened, for example cryogenically hardened. A utility knife 238 is utilized for tracing the external profile of the tracing plate 234 to fabricate a tile 240 that matches the profile of the tracing plate 234.

In operation, a piece of veneer 242 is placed upon an underlying support surface 244. The underlying support surface 244 is formed from a material that will not damage the blade of the utility knife 238. For example, the underlying support surface 244 may be provided by wood, rubber or a self healing mat, which is commonly used in arts and crafts for providing a surface that generally retains a smooth surface after multiple cuts thereupon.

The tracing template 232 is placed upon the veneer 242 with the tracing plate 234 directly upon the veneer 242. The tracing plate 234, veneer 242 and the underlying support surface 244 are collectively clamped together. The clamping action may be provided by a C-clamp or the like. Preferably, the clamping action may be provided by a high strength magnet 246 oriented underneath the underlying support surface 244. The magnet 246 may be a magnet, that is known in the art, that includes a lever for imparting a magnetic field upon the tracing plate 234 for clamping the tracing plate 234 and veneer 242 to the underlying support surface 244. Upon completion of tracing the tracing plate 234 with the utility knife 238, a tile 240 is provided that accurately matches the tracing plate 234. The tracing plate 234 is unclamped and the tile 240 is removed.

Once the tiles are cut, the tiles may be assembled and set providing an ornamental aesthetic tiled surface. Conventionally, there are three types of adhesives within the art, including wet glue, hot glue and double-sided adhesives. Double-sided adhesives are not recommended for wood on wood applications, since wood can expand and contract. Double-sided adhesives, however, have been accepted for use with thin veneers.

When assembling precut tiles to a surface, wet glues work best; but the parts may require to be clamped or held into position while the glue sets. Wet glue provides no immediate tact and the tiles can slide along the associated surface with the impart of a slight force when the glue is still wet.

To avoid such difficulties, the user may tape the tile pattern from the top and flip the pattern over onto a surface upon which a wet glue has been applied. Subsequently, the user may apply vacuum or pressure, which is commonly utilized with veneers or laminates. Clamping pressure is generally required in regular wood working as well.

Alternatively, if a user coats (by painting or spraying) the back (glue side) of a select solid wood board (one quarter inch to three eighths inch thick) with an engineered material, the double sided adhesives work effectively as long as the coating is compatible with the adhesive; the workpiece is applied to a stable engineered surface; and clamping pressure is applied for a period to ensure proper adhesion. Subsequently, the entire top surface can be sealed to ensure minimal expansion and contraction for the life of the applique. By using this method a woodworker has an option to make precision assemblies without using assembly templates and wet glues.

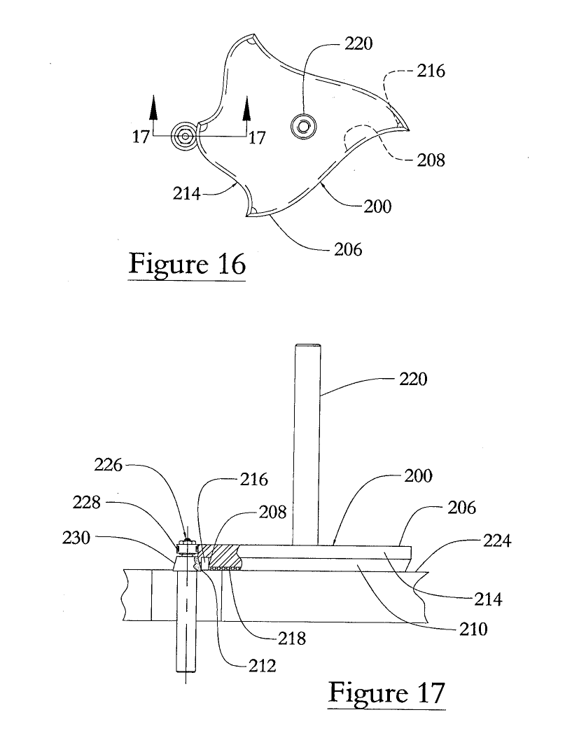

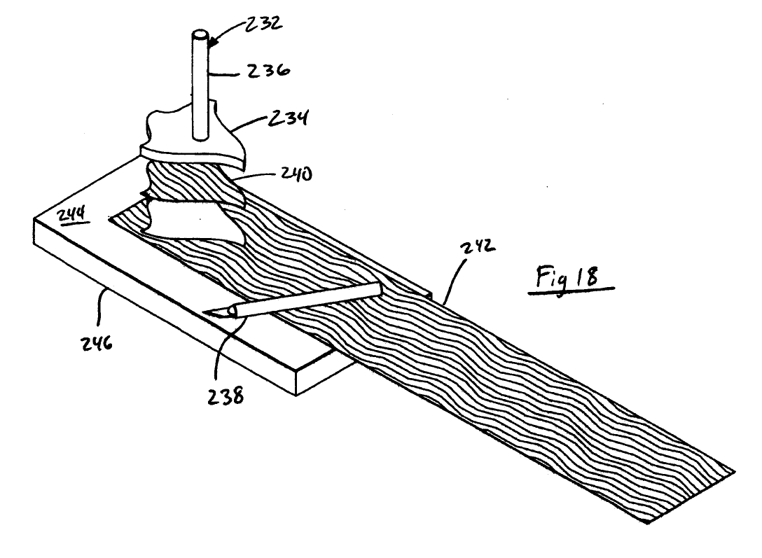

The present invention provides assembly jigs, which may be utilized for assembling multiple tiles. Accordingly, and with reference to FIGS. 19 through 24, assembly jigs and associated accessories and a method therefore are illustrated and described.

Referring now to FIG. 19a, an exemplary series of patterns are illustrated in accordance with the teachings of the present invention. The series of patterns are derived from the tile 104. The patterns include a six piece array 248, an eighteen piece array 250, a forty-two piece array 252, a seventy-two piece array 254, and a seventy-two piece pattern 256. The seventy-two piece array 254 is good for round table tops or floor inlays. The seventy-two piece pattern 256 may be utilized for laying out a linear run of material such as a hallway or an elongate table.

In order to assemble each of these patterns 248, 250, 252, 254, 256, a series of assembly jigs 258, 260, 262, 264, 266, are provided, each sized to receive the respective pattern. Each assembly jig 258, 260, 262, 264, 266 includes an aperture 268 formed therein that is sized to mate with the associated pattern to retain the pattern therein and maintain an assembled, interlocking orientation so that the associated pattern may be glued together in the desired pattern. FIG. 19d illustrates each of the assembly jigs 258, 260, 262, 264, 266 with the associated pattern 248, 250, 252, 254, 256 retained within the aperture 268.

Referring now to FIG. 19c, a series of associated assembly plates 270, 272, 274, 276, 278 are illustrated. Each of the assembly plates 270, 272, 274, 276, 278 has a simplified outline relative to the associated pattern 248, 250, 252, 254, 256. Each assembly plate 270, 272, 274, 276, 278 is retained within the underside of the associated assembly jig 258, 260, 262, 264, 266 and the associated pattern 248, 250, 252, 254, 256 is assembled thereon and glued thereto. Referring now to FIG. 19e, once the glue has dried, the assembly plates 270, 272, 274, 276, 278 are removed and each include the associated pattern 248, 250, 252, 254, 256 assembled and adhered thereto resulting in a precision finished pattern assembly 280, 282, 284, 286, 288.

Each assembly plate 270, 272, 274, 276, 278 may be sized so that similar pattern assemblies may be interconnected and assembled together for collectively providing the finished tiled surface. For example, the six piece array assembly 280, the eighteen piece array assembly 282, the seventy-two piece array assembly 286 and the seventy-two piece pattern assembly 288 are each interconnectable and can be joined with similar assemblies. Although the forty-two piece array assembly plate 274 is illustrated circular, an alternative plate could be provided having a profile that matches the geometry of the forty-two piece array 252.

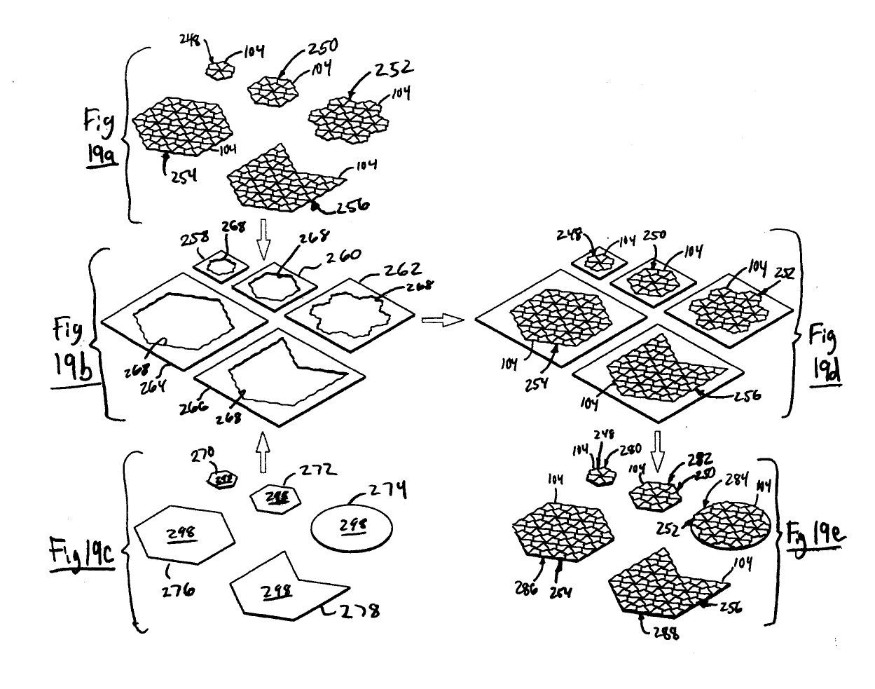

Referring now to FIG. 20, the six piece array assembly jig 258 and the associated six piece array assembly plate 270 are illustrated in greater detail. The aperture 268 includes a tile region 290 formed in an upper region of the aperture 268, that is sized to receive the tiles of the associated pattern 254. The aperture 268 also includes an assembly plate region 292, which is sized to receive a top portion of the associated assembly plate 270. Specifically, since the assembly plate 270 does not have a profile identical to that of the pattern 254, the assembly plate region 292 is formed by machining recesses 294 into the assembly plate region 292 of aperture 268. The recesses 294 each collectively provide a step such that the associated assembly plate 276 can be inserted into the assembly jig 258 to a predetermined depth.

The six piece array assembly plate 270 includes a tongue and groove profile 296 formed about its periphery. The tongue and groove profile 296 permits adjacent assembly plates 270 to be assembled together and interlocked together thereby enhancing the connection between adjacent assembly plates 270. The assembly plate 270 can be formed of wood or the like and may be fabricated by the user with a router template (not shown). The router template may be similar to the router template 100 having a nest to receive a stock piece, a hexagonal bearing path, a hexagonal cutting path and a window to view from the opposing side. In order to obtain the tongue and groove profile 296, a tongue cutter router bit (not shown) is utilized for cutting three of the sides and a groove cutting router bit (not shown) is utilized for cutting the other three sides.

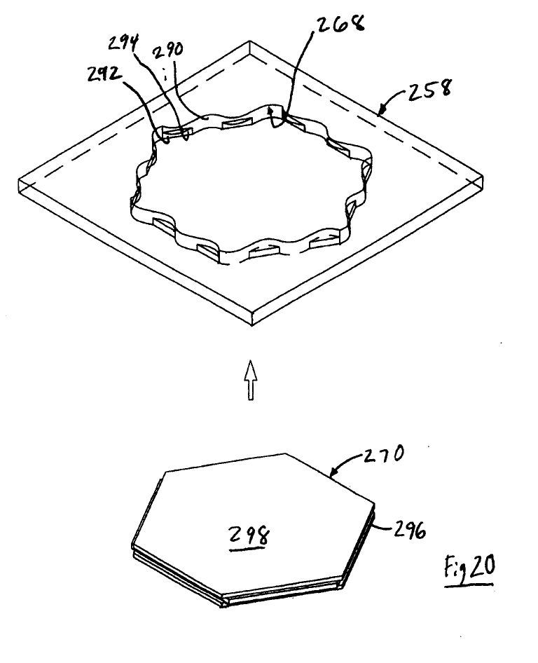

To assemble the associated pattern, the assembly plate 270 is partially inserted into the assembly plate region 292 formed in the aperture 268 of the assembly jig 258. The user applies an adhesive upon a top surface 298 of the assembly plate 270 prior to insertion in the aperture 268. Alternatively, the adhesive may be applied subsequent to placing the assembly plate 270 in the aperture 268. Referring now to FIG. 21, the assembly jig 258 is illustrated with the assembly plate 270 retained within the assembly plate region 292. Then, the user assembles the six piece array 248 by inserting the tiles 104 one at a time into the tile region 290 of the aperture 268. After the six piece array 248 has been assembled, it is retained within the assembly jig 258 until the glue at least partially dries and the tiles 104 each bond with the assembly plate 270 and to each other, as illustrated in FIG. 22. Once assembled, the assembly jig 258 and six piece array assembly 280 can be vacuum sealed, and/or cold-pressed or heated and pressed for quick adhesion.

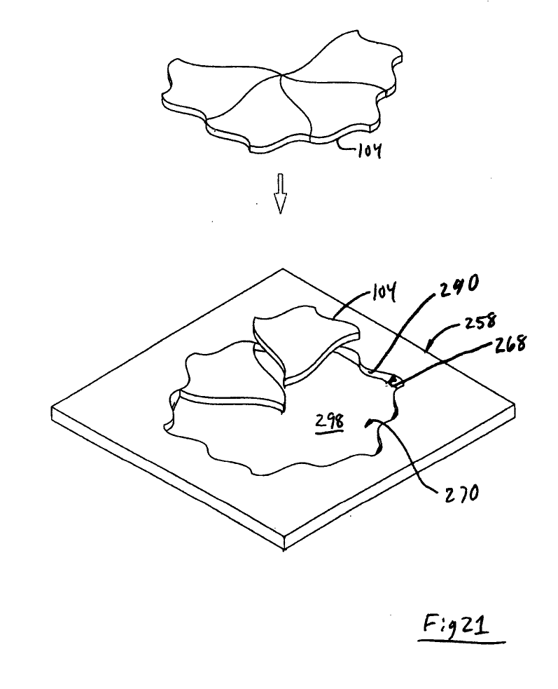

Referring to FIG. 23, upon proper adhesion time, the six piece array assembly can be removed from the aperture 268 for reuse of the assembly jig 258. The assembly jig 258 ensures highly repeatable interlocking conditions between pattern assemblies 280. Since the six piece array 248 has a generally hexagonal profile with peaks at six equidistant points, the associated assembly plate 270 is generally hexagonal with peaks at the same equidistant points. Thus, each side of the polygon bisects the overlaps and underlaps of each tile 104 so that when adjacent assembly plates 270 are assembled together, the adjacent six piece arrays 248 are assembled together as well.

Referring now to FIG. 24, an alternative embodiment six piece assembly plate 300 is illustrated in accordance with the teachings of the present invention. The six piece assembly plate 300 is similar to the six piece assembly plate 270 illustrated in FIGS. 19-23; however the six piece assembly plate 300 does not have a purely hexagonal profile. Rather, the six piece assembly plate 300 has a profile sized to identically mate with that of the six piece array 248.

The tile pattern may be applied to a desired surface to completely cover the surface. For example, if applied upon a piece of furniture, the tile pattern may be applied such that it completely covers and partially extends from a peripheral edge thereof. Accordingly, to finish the surface, excess portions of the tile pattern that extend over the peripheral edge are removed, such as by cutting the excess material off with a saw, router, or the like. However, it may be desired to cover or finish the peripheral edge of the tiles and associated assembly plate with a border.

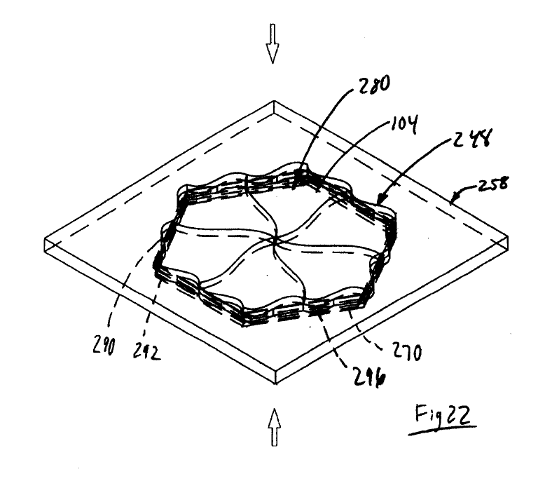

Referring now to FIG. 25, an exemplary piece of furniture, specifically, a round end table 302 is illustrated with a tile pattern assembly 304 in accordance with the present invention. The tile pattern assembly 304 includes a tile array 306 that is adhered to an assembly plate (not shown). The assembly plate is circular and therefore does not mate with an external profile of the tile array 306. Accordingly, the tile array 306 is assembled to the tile plate generally overlapping its outward edges and extending therefrom. Subsequent to the assembly adhesion process, the excess portions of the overlapping tiles are cut off by a router that follows the profile of the assembly plate. Alternatively, the assembly plate could be originally oversized and the assembly plate and tile array 306 could be cut concurrently to the finished tile pattern assembly 304 size in a single cutting or routing process.

The outward peripheral edges of the tile pattern assembly 304 are bordered by a plurality of table top chords 308 that are each sized to connect and assemble with adjacent chords, and to collectively retain the tile pattern assembly 304 therein. To enhance the structural soundness of the table top, the tile pattern assembly 304 may be provided with one of a tongue or groove configuration, preferably within the assembly plate; and the table top chords 308 may each be provided with the other of a tongue or groove configuration. Each of the table top chords 308 may also be biscuit joined together or engaged by a tongue and groove configuration to enhance the interconnection. The remainder of the round end table 302 may be assembled from a series of legs 310 extending from the table top, and with table skirts 312 extending below the table top and interposed between sequential legs 310.

Referring now to FIG. 26, an alternative embodiment round end table 314 is illustrated in accordance with the present invention. The round end table 314 utilizes the seventy-two piece array assembly 286. A series of table top chords 316 are each provided with an inboard profile sized to mate with a corresponding region of the seventy-two piece tile assembly 254. Further, each of the table top chords 316 includes one of a tongue or groove configuration to engage the associated seventy-two piece assembly plate 276. Alternatively, the table top could be provided from a unitary piece of wood with a recess cut therein to receive the seventy-two piece array 254 as an inlay.

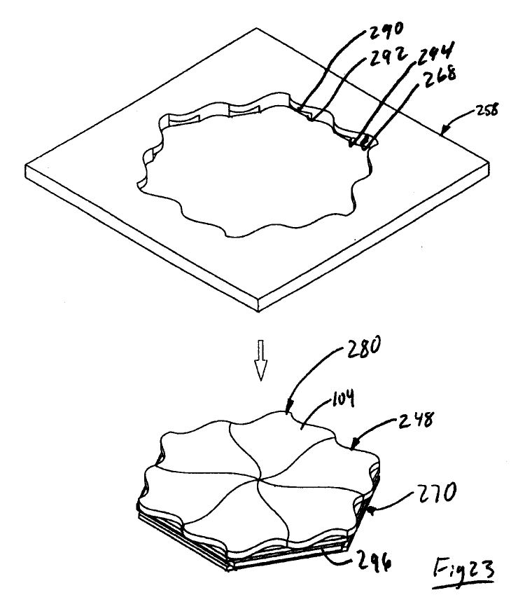

With reference now to FIG. 27, a staircase 318 is illustrated within the spirit and scope of the present invention. Each step 320 of the stair case 318 includes a plurality of inlays, specifically each inlay being provided by the six piece array 248. Recesses are provided within each step 320 and the six piece array 248 is assembled and adhered within the recess.

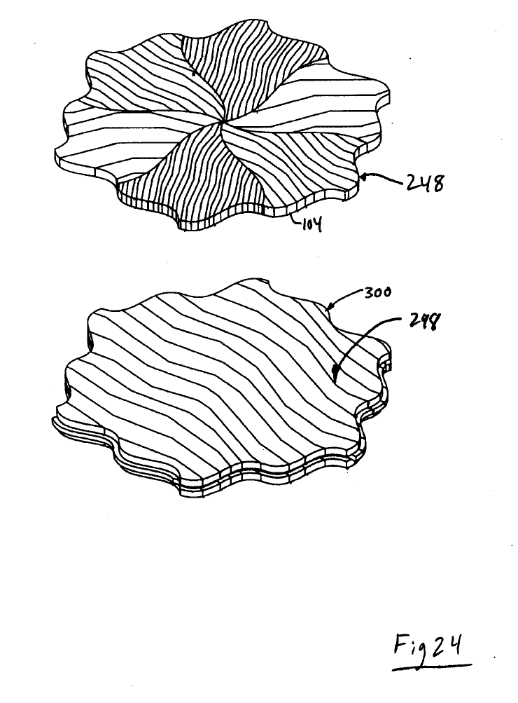

Referring now to FIGS. 28 and 29, an inlay template 322 is illustrated in accordance with the teachings of the present invention. The inlay template 322 is utilized for cutting out an inlay recess within a finished work surface to receive a tiled pattern therein. Specifically, the inlay template 322 is sized to generate an inlay recess for the six piece array 248 of tiles 104. The inlay template 322 is formed from a flat piece of stock, preferably aluminum stock and includes a router bearing path 324 formed therethrough, which partially circumscribes a desired inlay profile. Additionally, the inlay template 322 includes a plurality of retaining pins 326 for securing the inlay template 322 to a workpiece prior to cutting the inlay recess.

With reference now to FIG. 30, which is a section view taken through section line 30-30 of FIG. 29, the inlay template 322 is illustrated upon a workpiece 328 in cooperation with a cutting tool, specifically a router 330. The inlay template 322 includes a plurality of pin apertures 332 and pin body bores 334 each for receiving a respective pin end 336 and pin body portion 338 of the corresponding retaining pin 326. The upper region of each pin body bore 334 is threaded for receiving an associated set screw 340 therein for fastening the retainer pin into the inlay template 322.

The pin body bores 334 and pin apertures 332 are oriented both internal to, and external of, the perimeter of the inlay recess so that the inlay template 322 may be secured to a scrap portion 342 of the workpiece 328 and/or the inlay template 322 may be secured to the workpiece 328.

The router 330 is illustrated in cooperation with a router bit 344. The router bit 344 includes a guide bearing 346 and a cutter 348. The cutter 348 is both an end cutter and a side cutter for cutting axially through the workpiece 328 and for cutting laterally as the router 330 is translated along the bearing path 324. The inlay template 322 also includes a cutter path 350 for providing clearance to the cutter 348 and for permitting airflow to pass therethrough for debris removal, which may be vacuum assisted.

The router bit 344 is illustrated extending to a depth that passes through the workpiece 328, thereby creating an inlay aperture 352 for receiving the associated pattern, specifically the six piece array 248. In assembly, the workpiece 328 is secured upon a substrate and the six piece array 248 is assembled within the inlay aperture 352 upon the associated substrate. Alternatively, the inlay aperture 352 may receive the six piece array 248 of the six piece array assembly 280 and the associated assembly plate 270 may be affixed to the underside of the workpiece 328. Of course, the router bit 344 may be set to a depth that does not completely pass through the workpiece 328 thereby leaving an inlay recess wherein the six piece array 248 may be inserted into the recess and assembled therein, without requiring an assembly plate or a substrate.

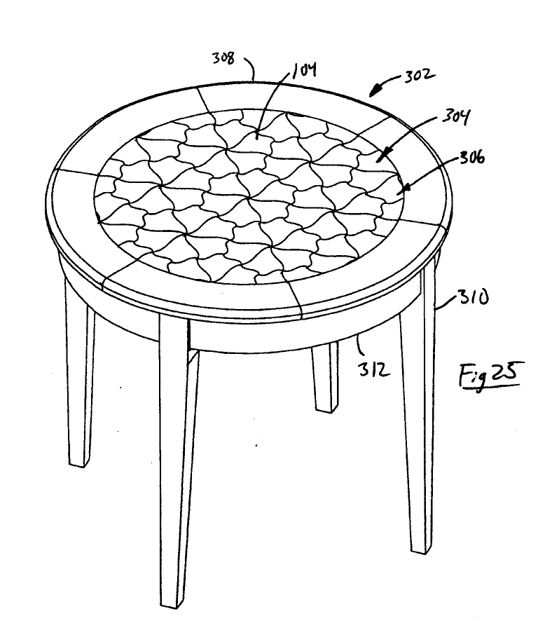

Referring now to FIG. 31, the setup of the inlay template 322 is illustrated. Specifically, the user aligns the inlay template 322 with the workpiece 328 and presses the inlay template 322 into position by tapping upon the template with a mallet so that the pin ends 332 are inserted into the workpiece 328. Of course, if it is undesired to utilize retaining pins 326 in the region external to the inlay profile, the user may elect to utilize the retaining pins 326 only in the region that is internal of the inlay profile. When using retaining pins 326 in the internal region only, the user may secure the inlay template 322 to the workpiece 328 and then clamp positional guides about the template 322 so that the position may be maintained upon completion of cutting the profile. Alternatively, a scrap board may be clamped to the workpiece 328 and the template may be affixed upon the scrap piece so that holes from the retaining pins 326 are formed in the scrap piece only. Alternatively, the inlay template 322 may be provided with the pins in the opposite direction such that the inlay template 322 is adhered to the underside of the workpiece 328 and the cutting operation is performed from below so that the holes from the retaining pin 326 are not provided within the top surface of the workpiece 328. In the alternative, the template 322 may be provided with through holes to receive wood screws for fastening the template 322 during the completion of the profile.

The inlay template 322 includes a pair of ingress/egress apertures 354, 354′ each located at a terminal end of the bearing path 324. The ingress/egress apertures 354, 354′ each have a diameter greater than the width of the bearing path 324 so that the cutter 348 of the router bit 344 may be inserted into the cutter path 350 and the guide bearing 346 may then be subsequently inserted into the bearing path 324. The ingress/egress apertures 354, 354′ are each located within the inlay profile so that the inlay aperture 352 is not inadvertently exceeded.

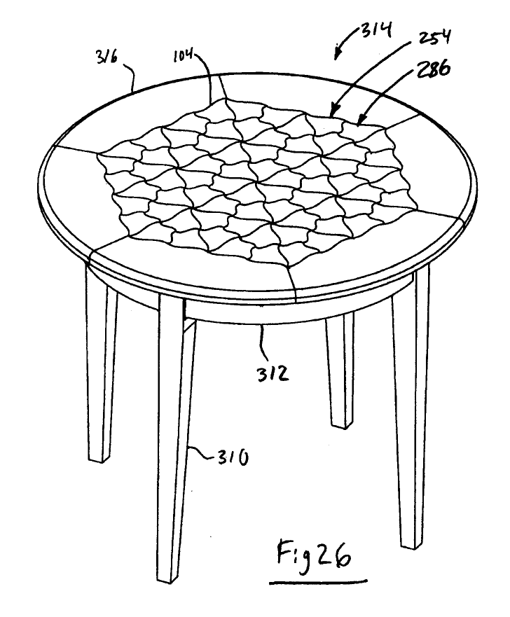

Referring now to FIG. 32, the cutting operation of the inlay aperture 352 is illustrated. Specifically, the router bit 344 is inserted into one of the ingress/egress apertures 354, 354′. The router 330 is turned on to impart a rotation to the router bit 344. A manually predrilled hole (not shown) is applied to the workpiece 328 prior to inserting the router bit 344. The predrilled hole is formed deeper than the inlay depth, and smaller in diameter than the ingress/egress hole, but larger in diameter than the router bit 344. Alternatively, as the router bit 344 is inserted into the ingress/egress aperture 354, a downward cutting operation through the workpiece 328. Although a fixed base router 330 is illustrated, a plunge base router may also be utilized, or the inlay template 322 may be utilized with a conventional router table or shaper. Once the cutting operation begins, the user guides the router 330 such that the guide bearing 346 engages an outboard bearing region 356 of the bearing path 324. The user translates the router 330 along the bearing path 324.

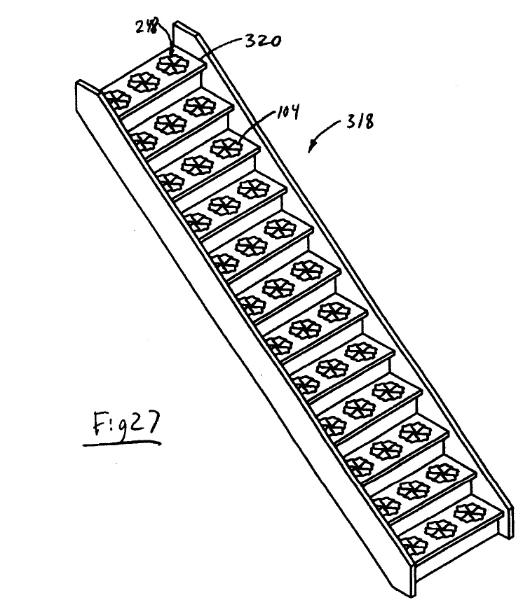

Referring now to FIG. 33, the router 330 is illustrated at an intermediate position along the bearing path 324 during the cutting operation. Subsequently, and with reference to FIG. 34, the router 330 is translated into a position wherein the router bit 344 is oriented within the other ingress/egress aperture 354′. The user turns the router 330 to an off position thereby discontinuing the power and consequently rotation of the router bit 344. The router bit 344 is removed from the ingress/egress aperture 354′ by raising the router 330 from the workpiece 328.

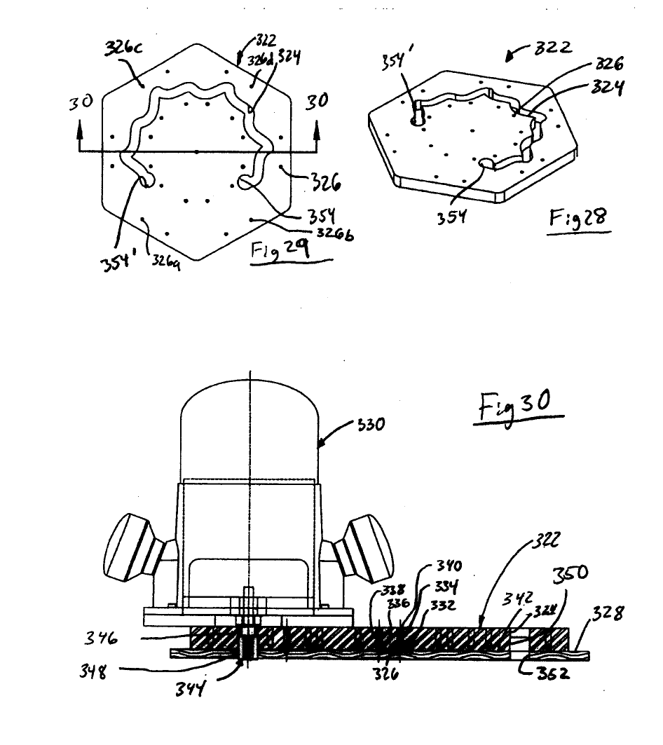

Upon completion of the first path of the cutting operation, the inlay template 322 is removed from the workpiece 328 as illustrated in FIG. 35. Referring to FIG. 36, the inlay template 322 is rotated one hundred and eighty degrees, and the inlay template 322 is remounted to the workpiece 328. The retaining pins 326 are oriented relative to the inlay profile in a symmetrical radial array such that the holes imparted into the workpiece 328 from the first pass of the cutting operation may be reused for affixing the inlay template 322 to the workpiece 328 for performing the second pass of the cutting operation.

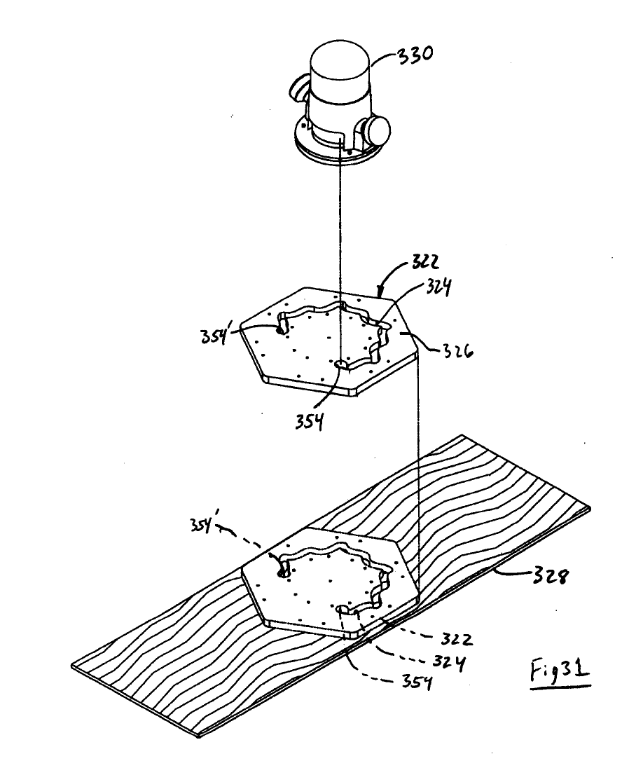

Referring now to FIG. 37, the router 330 is oriented such that the router bit 344 is aligned with the ingress/egress port 354. Subsequently, the router is translated along the bearing path 324 to a position along the bearing path 324 wherein the first pass of the cutting operation terminated. The router 330 is powered to an on position and the router 330 is maneuvered along the bearing path 324. FIG. 38 illustrates an intermediate position during the second pass of the cutting operation. Upon completion of the second pass of the cutting operation, the power to the router 330 is discontinued, the router bit 344 is aligned with the ingress/egress aperture 354′ and the router 330 is removed from the workpiece 328. Accordingly, as illustrated in FIG. 39, the inlay template 322 is removed from the workpiece 328.

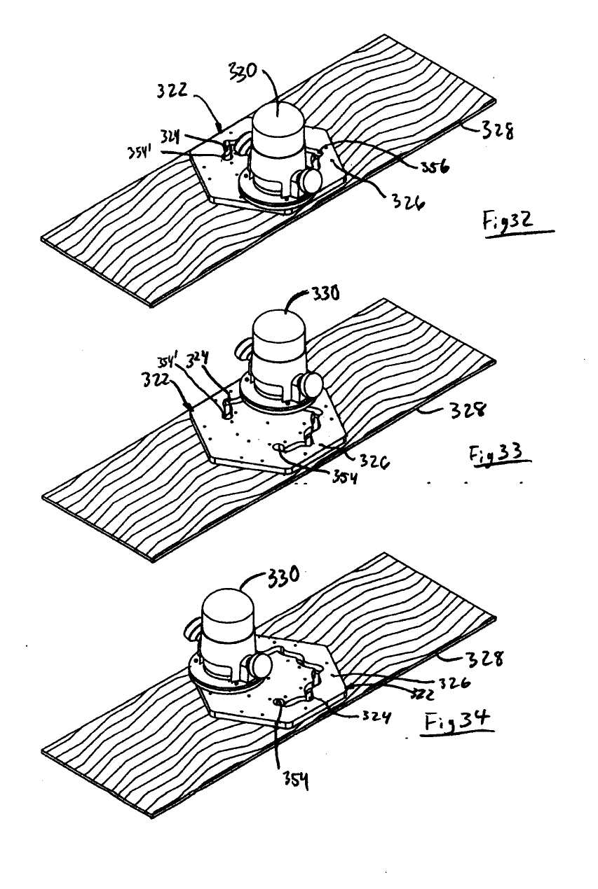

Referring now to FIG. 40, the scrap portion 342 is removed from the workpiece 328. If an inlay recess was being cut into the workpiece 328, rather than the inlay aperture 352, the center scrap portion 342 could be removed by cutting this portion with a router set to the depth cut during the cutting operation. Alternatively, the router template 322 may be provided with a continuous bearing path 324 and associated cutting path 350 such that the entire aperture may be cut in one continuous cutting pass. If an inlay recess were being cut, the template may be mounted to the workpiece 328, and the router 330 may be utilized to cut the entire recess into the workpiece 328.

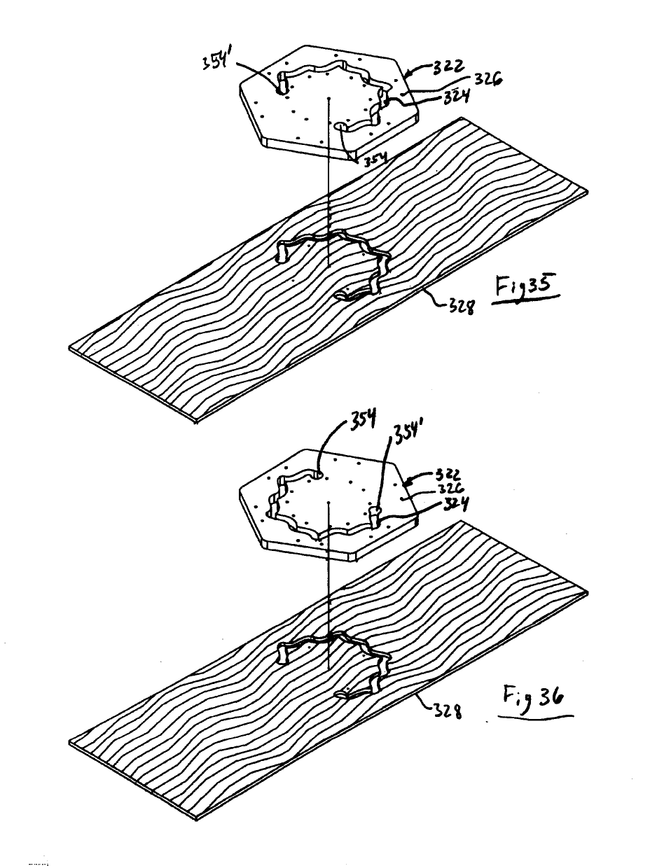

Referring now to FIGS. 41 and 42, the workpiece 328 is provided with the inlay aperture 352 formed therein. Due to the specific profile of the six piece array 248, sharp corners must be cut into the inlay aperture 352 in order to receive the six piece array 248. Referring to FIG. 42, these sharp corners are not provided by the router cutting operation because the corners of the profile are limited by the diameter of the cutter 348 of the router bit 344.

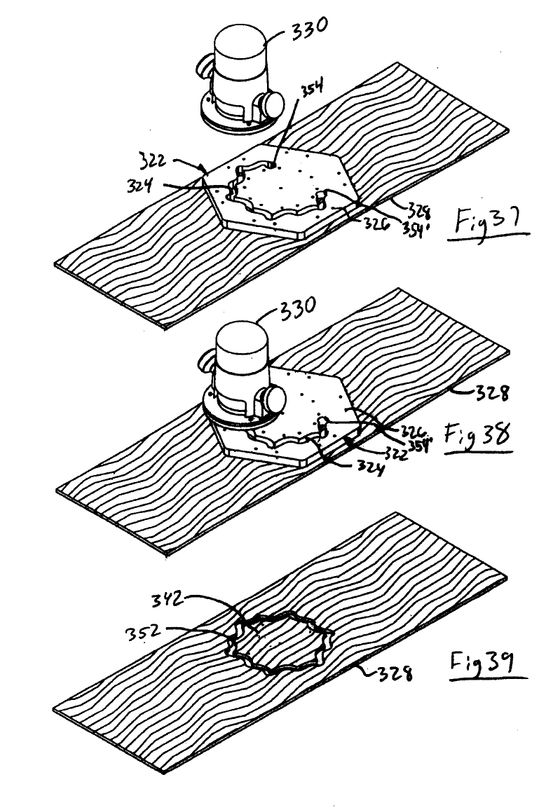

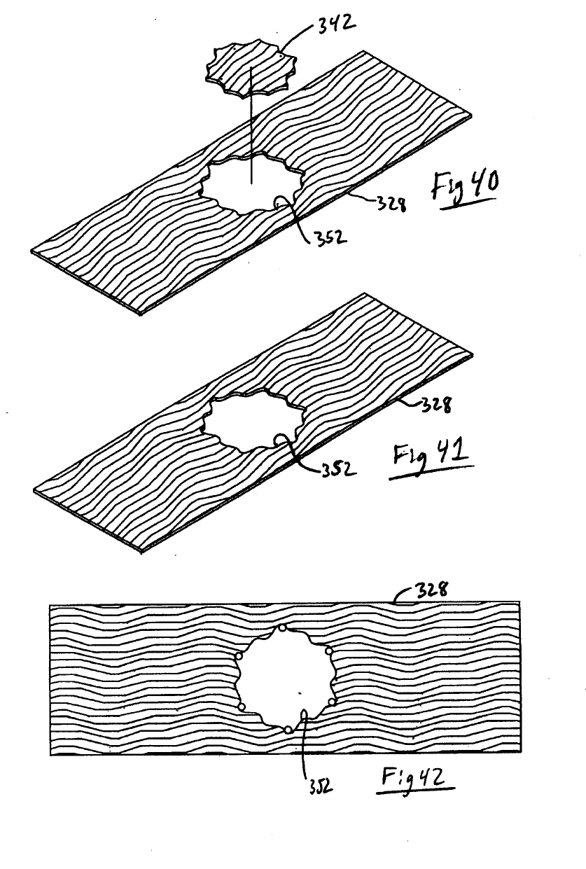

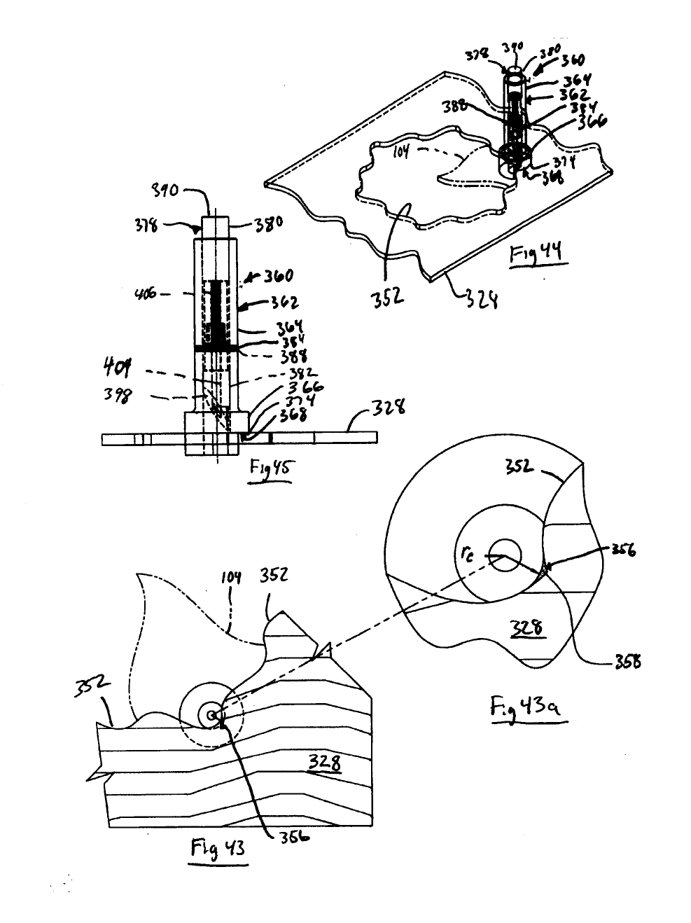

With reference now to FIG. 43, a portion of the workpiece 328 is illustrated including a portion of the inlay aperture 352. One of the tiles 104 that is to be received within the inlay aperture 352 is illustrated in phantom. A peak of the tile 104 that creates an inner corner 356 within the inlay aperture 352 is illustrated. A radius of the cutter 348 is illustrated and labeled r_{c}. As FIG. 43a illustrates, the radius r_{c} of the cutter 348 is limited and is uncapable of cutting the profile of the inner corner 356, thereby leaving an inner corner scrap portion 358. In order to assemble the six piece array 248 within the inlay aperture 352, each of the inner corner scrap portions 358 should be removed.

Referring now to FIGS. 44 and 45, an inner corner punch 360 is illustrated for removing the inner corner scrap portion 358 from the inlay aperture 352. FIGS. 44 and 45 both illustrate the inner corner punch 360 in a setup position relative to the workpiece 328.

The inner corner punch 360 includes a body 362, which is illustrated in greater detail in FIG. 46. The body 362 includes an elongate tubular handle 364 with a hub 366 formed at a distal end of the handle 364. The handle 364 permits a user to grasp the punch body 362 and orient the punch 360 relative to the workpiece 328. The hub 366 includes a recess 368 formed at its distal end partially through a lateral sidewall thereof. The recess 368 provides an alignment surface 370 that is generally parallel to the handle 364, and which is shaped in size to engage the inlay aperture 352. Since the punch 360 is utilized for cooperation within the inner corner 356, the alignment surface 370 is provided by at least a pair of alignment pads 372, 372′, each of which are sized to engage a corresponding inlay aperture surface, of which collectively provide the inner corner 356. The recess 368 also provides an undercut step 374 formed within the underside of the hub 366. The step 374 is generally orthogonal to the handle 364 such that the body 362 may rest upon and be supported perpendicular to the associated workpiece 328.

The body 362 includes a longitudinal bore 376 formed therethrough for receiving a punch shaft 378 therein. The punch shaft 378 is illustrated in FIGS. 44 and 45 assembled within the inner corner punch 360, and is also illustrated in detail in FIG. 47. The punch shaft 378 is received and retained within the longitudinal bore 376 for longitudinal translation therein. The punch shaft 378 includes a pair of cylindrical bearing regions 380, 382 for radial bearing alignment within the inner bore 376 to properly maintain the position of the punch shaft 378 during the punching operation.

The body 362 includes a transverse aperture 384 formed through the handle 364. The punch shaft 378 includes a corresponding transverse slot 386 formed therethrough. Upon assembly of the punch shaft 378 within the bore 376 of the body 362, a pin 388 is inserted into the transverse aperture 384, which extends through and cooperates within the transverse slot 386. The pin 388 permits the punch shaft 378 to translate relative to the body 362 in a range of longitudinal motion that is defined by the upper and lower extents of the transverse slot 386. Additionally, the pin 388 prevents rotation of the punch shaft 378 relative to the body 362 to ensure proper radial alignment of the punch shaft 378 relative to the body 362.

The punch shaft 378 includes an anvil 390 formed at a distal end thereof that is sized to extend out of the longitudinal bore 376, in an unloaded orientation of the punch shaft 378. The punch shaft 378 also includes a blade 392 formed at the lower distal end thereof spaced apart and opposed from the anvil 390.

The blade 392 is sized to cut and remove the inner corner scrap portion 358 from the inner corner 356. Accordingly, the blade 392 is retained within the inner bore 376 in an unloaded orientation of the punch shaft 378. The inner bore 376 intersects the alignment surface 370 so that the blade 392 may be actuated therethrough to perform the punching operation.

Specifically, the blade 392 includes a first cutting edge 394 and a second cutting edge 396, which collectively are sized to cut the inner corner 356 into the inlay aperture 352, while removing the inner corner scrap portion 358. The first cutting edge 394 and the second cutting edge 396 are defined by a rake surface 398 formed in the underside of the punch shaft 378, and a first relief surface 400 and a second relief surface 402, which are each formed in a lateral side portion of the blade 392, adjacent and intersecting with the rake surface 398.

The punch shaft 378 includes a blind bore 404 disposed longitudinally therein. The blind bore 404 receives a compression spring 406 therein during an assembled state of the inner corner punch 360. The compression spring 406 engages the pin 388 and the blind end of the bore 404 to extend the punch shaft 378 upward in an unloaded position of the punch shaft. Accordingly, in this unloaded position, the anvil 390 extends out of the longitudinal bore 376 of the handle 364. To perform the punching operation, the user taps the anvil 390 with a hammer or mallet, thereby actuating the punch shaft 378 downward and the blade 392 consequently engages the workpiece 328 and removes the inner corner scrap portion 358. The slot 386, which cooperates with the pin 388, limits the range of downward longitudinal translation of the punch shaft 378 relative to the body 362. Upon completion of the punching operation, the spring 406 extends the punch shaft 378 upward, thereby retracting the blade 392 from the inlay aperture 352. In the upward stroke, the slot 386 also limits the range of translation of the punch shaft 378.

The body 362 and punch shaft 378 are preferably both formed from steel. Preferably, the punch shaft 378 is formed from tool steel. The body 362 and punch shaft 378 are each machined to ensure accuracy and repeatability of the punching operation. The punch shaft 378 is preferably hardened, such as by cryogenically hardening, to enhance performance and life of the inner corner punch 360. Although the inner corner scrap portion 358 may be removed by other means, such as utilization of a wood chisel, file or the like, the inner corner punch 360 provides a completed inlay aperture 352 within prescribed tolerances that minimizes the gap between the inlay aperture 352 and the associated tiles 104.

Referring now to FIG. 48, another apparatus and method for providing an inlay for a tile pattern is illustrated. Specifically, a border template 408 is illustrated for cutting a border or a series of borders for providing a uniform edge about a tile pattern. The border template 408 is utilized with a workpiece 410 for cutting the workpiece 410 into an elongate border piece 412 having an inlay profile 414 sized for engaging and receiving a tile pattern such as the seventy-two piece pattern 256 illustrated.

The border template 408 has a predescribed length that is less than that of the border piece 412. However, due to the repetition in the inlay profile 414, the border template 408 may be utilized for cutting a border, such as the border piece 412, that has a length greater than that of the border template 408. Accordingly, the border template 408 may be utilized to cut various border pieces such as the border piece 412 and other border pieces such as border piece 416 for encompassing the desired pattern.

The border template 408 includes a profile bearing path 418 that is sized and profiled to receive a guide bearing of a router bit for cutting the inlay profile 414 into the border pieces. The border template 408 also includes a first miter bearing path 420 and a second miter bearing path 422, each of which provides a bearing surface for the guide bearing of the router bit for cutting a respective first miter 424 and a second miter 426 into the border piece 412. The first miter 424 and the second miter 426 are each cut into the border piece 416 to intersect the inlay profile 414 at a peak in the pattern profile.

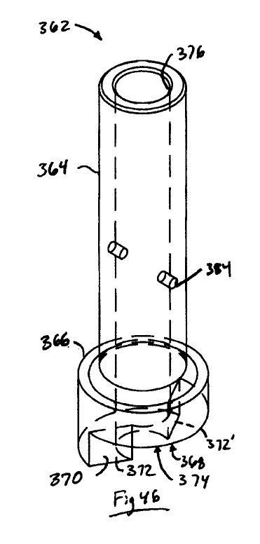

Referring now to FIGS. 49, 50 and 50a, the setup of the border template 408 is illustrated in detail. The border template 408 includes two linear arrays of incrementally spaced counter-bored holes 428 aligned transversely along the border template 408. The counter-bored holes 428 are each sized to receive a gauge pin 430 therein. Each gauge pin 430 has a shoulder 432 that is received within the counter-bored hole 428, and a pin body 434 that extends through the border template 408. The gauge pins 430 are utilized for selecting a desired width of the border piece that is to be cut from the workpiece 410. The user selects the desired width of the border piece by placing the gauge pins 430 in a pair of corresponding counter-bored holes 428. Then the border template 408 is oriented relative to the workpiece 410 such that the pin bodies 434 of the gauge pins 430 engage an outboard surface of the workpiece 410. Subsequently, the border template 408 is secured to the workpiece 410.

The border template 408 also includes three series of pin apertures 436, each being counter-bored for receiving a retaining pin 438. Each retaining pin 438 includes a pin body 440, a pin end 442 and a shoulder 444. The pin bodies 440 are inserted into the pin apertures 436 and the shoulder 444 is tapped by a hammer or a mallet such that the pin end 442 pierces the workpiece 410, until the shoulder 444 is disposed in the counter-bore of the corresponding pin aperture 436. Of course, the border template 408 may be utilized with the underside of the workpiece 410 so that holes provided by the pin end 442 in the workpiece 410, are formed in the underside to avoid marring a finished surface. Additionally, the invention contemplates utilization of other means for securing the border template 408 to the workpiece 410, such as clamps, vices, vacuum seals, nesting or the like.

Precise and repeatable locating of the border template 408 to the workpiece 410 is obtained by utilization of the gauge pins 430 and the retaining pins 438. The series of pin apertures 436 are incrementally spaced longitudinally along the border template 408 such that the border template 408 can be raised and removed from the workpiece 410 and subsequently repositioned incrementally to accommodate the workpiece 410 that extends past the length of the border template 408. FIG. 49 illustrates the border template 408 in both a first position in solid and in a second incrementally spaced position in phantom.

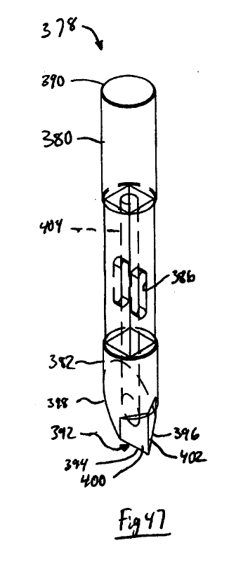

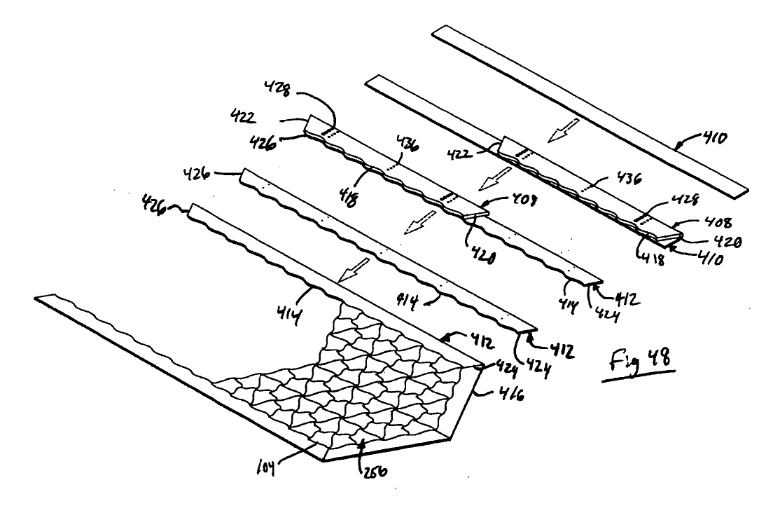

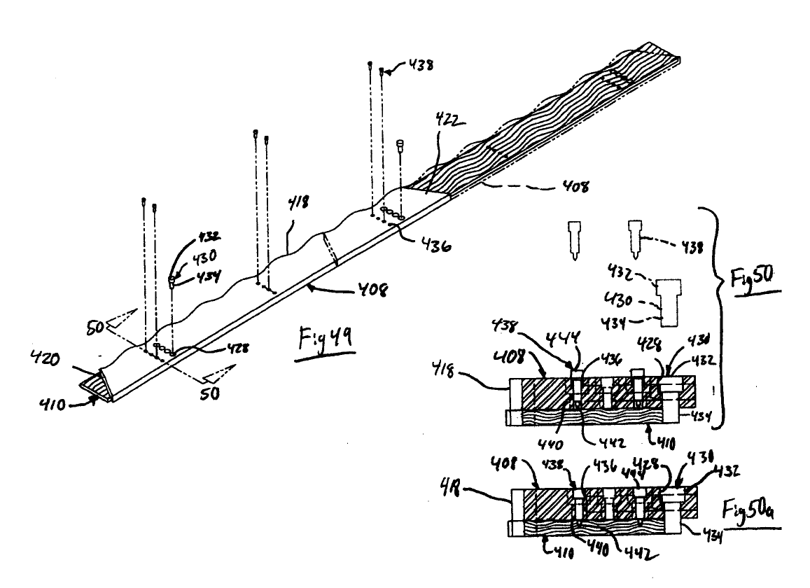

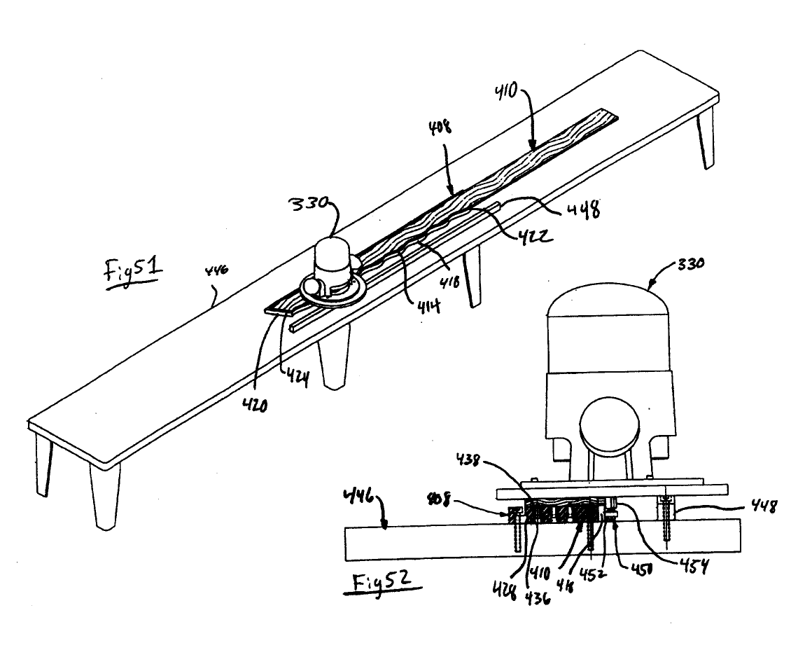

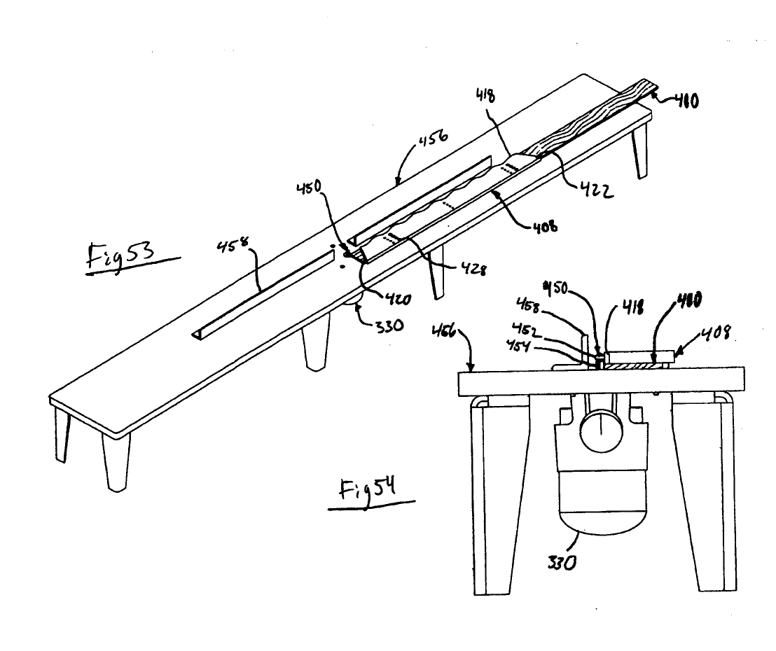

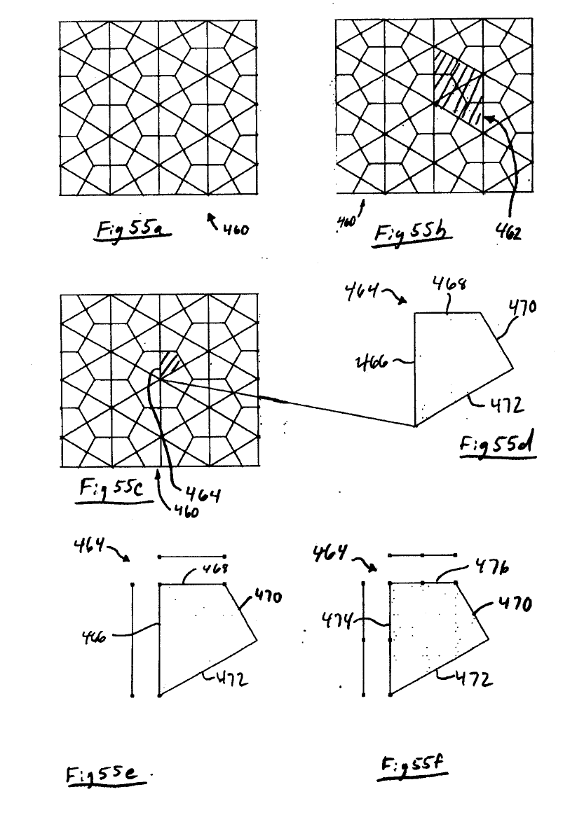

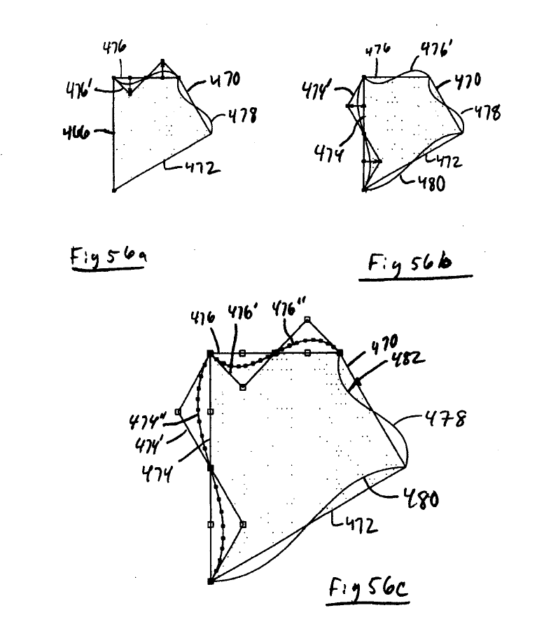

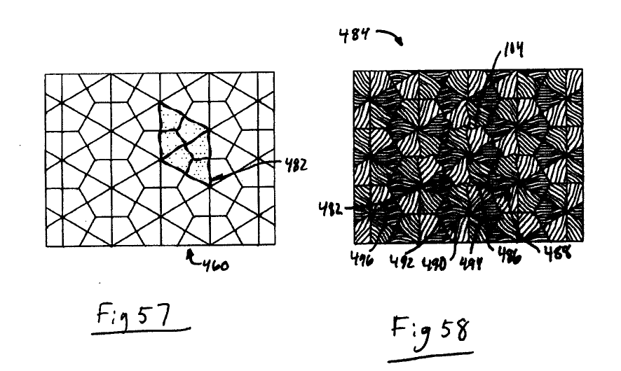

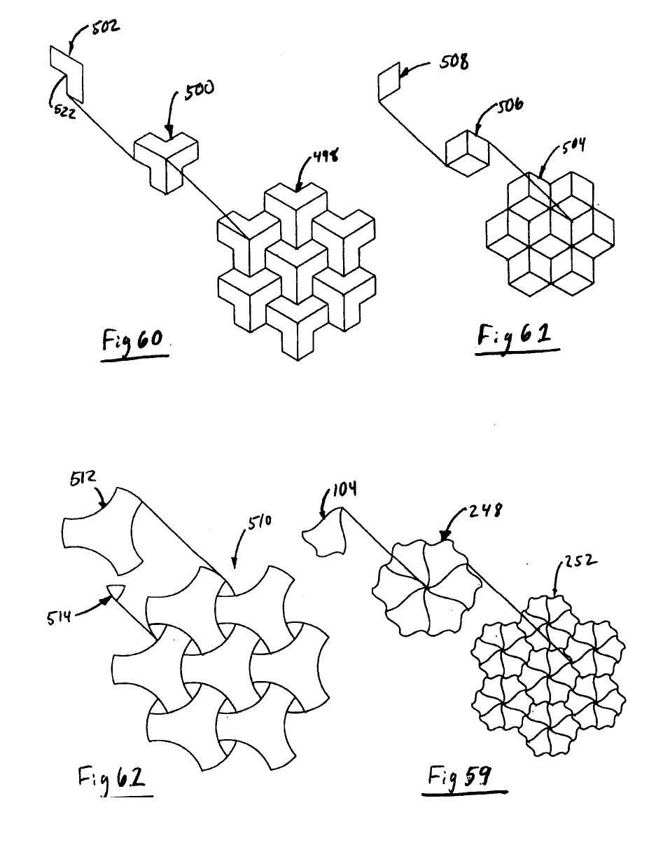

Referring now to FIGS. 51 and 52, an exemplary cutting operation is illustrated utilizing the border template 408. The border template 408 is fastened upon a top surface of a table 446. The workpiece 410 is retained upon the border template 408 by utilization of the retaining pins 438. The retaining pins 438 are retained within the pin apertures 436 due to the cooperation of the border template 408 upon the table 446. Rather than tapping the retaining pins 438, the user taps the workpiece 410 with a hammer or mallet to secure it upon the border template 408.

A riser block 448 is provided upon the table 446 spaced apart from and aligned adjacent to the border template 408. The riser block 448 has a height generally equivalent to the combined height of the border template 408 and the workpiece 410. A router, such as the handheld router 330 is utilized for providing the cutting operation. The router 330 includes a router bit 450 having a guide bearing 452 for engaging the profile bearing path 418 of the router template 408, and a side cutter 454 for performing the cutting operation by cutting through the workpiece. The base of the router 330 is supported upon the workpiece 410 and the riser block 448 during the cutting operation.

During the cutting operation, the user guides the router 330 along the workpiece so that the guide bearing 452 engages the profile bearing path 418, the first miter bearing path 420 or the second miter bearing path 422. The user cuts a desired length of the profile into the workpiece 410. If the workpiece 410 is longer than the router template 408, the user advances the workpiece 410 along the router template 408 in incremental length as described by the orientation of the retaining pins 438. Of course, if a border piece is desired that is shorter than the border template 408, such as border piece 416, the workpiece 410 is, after the first cut, advanced along the border template 408 in the opposite direction so that a shorter length can be cut as the second miter 426 is cut into the workpiece 410.

With reference now to FIGS. 53 and 54, the router template 408 is illustrated in cooperation with a router table 456. The router table 456 includes a router mounted on an underside of a top table surface thereof, such as the router 330. The router 330 includes the router bit 450 extending upward and through the table. The border template 408 and the workpiece 410 are secured together, for example by engagement of the retaining pins 438, and placed upon the table with the workpiece 410 directly upon the table. The router table 456 is illustrated with a router fence 458 provided thereon, however the router fence 458 may be removed if necessary to make room for the cutting operation. The router bit 450 is extended to a height wherein the guide bearing 452 engages the profile bearing path 418, the first miter bearing path 420 and the second miter bearing path 422. This height also displaces the cutter 454 at a height to engage and cut the workpiece 410. Accordingly, the user translates the border template 408 and the workpiece 410 along the top surface of the router table 456 with the desired bearing path 418, 420 and/or 422 engaging the guide bearing 452 as the cutter 454 cuts the workpiece 410.

As discussed above, the templates and methods illustrated and described can be utilized for fabricating tiles and tile patterns. These tiles and tile patterns may include tessellations. Tile 104 is formed from a tessellation that is incorporated into the templates. Referring now to FIGS. 55a-59, methods of generating the above described templates, such as router template 100 are illustrated. Although the method is discussed with reference to software, the invention contemplates that the method can be performed by conventional mathematics.

Referring specifically to FIG. 55a, a desired tessellation geometry 460 is generated, for example by software in a Computer-Aided Design (CAD) environment. Specifically, the geometry 460 is a pattern that includes a single repeatable component that is arrayed across the pattern of the geometry 460. Of course, any Euclidean or non-Euclidean geometry, tessellation, pattern or the like is contemplated within the spirit and scope of the present invention.

Subsequently, with reference to FIG. 55b, a lattice cell 462 is isolated from the geometry 460. The lattice cell 462 is illustrated shaded within the geometry 460.

The next step is illustrated in FIGS. 55c and 55d wherein a fundamental region 464 (shaded in FIG. 55c) is isolated from the lattice cell 462. The fundamental region 464 is illustrated removed from the lattice cell 462 and the geometry 460, and enlarged in FIG. 55d. Fundamental region 464 is a four sided polygon. The polygon is formed from four line segments, which are labeled 466, 468, 470, 472 as viewed clockwise about the fundamental region perimeter in FIG. 55d and beginning with the vertical line segment. Since the generation of a tessellation results in interlocking tiles, changes made to the fundamental region 464 are repeated. Specifically, changes made to line segment 466 must be duplicated for line segment 472, specifically arrayed about the included angle therebetween. Likewise, changes made to line segment 468 must be made for line segment 470 as well, also arrayed about the included angle therebetween.

With reference to FIG. 55e, the fundamental region 464 is illustrated with the end points marked by datum boxes to indicate the end points of both line segment 466 and line segment 468. In order for each line segment 466, 468, to generally represent a free form, the line segments 466, 468 are each converted to a spline. A spline is a line that is divided into line segments wherein each line segment is derived from a simple function; and the line segments are collectively joined at their end points. Therefore, the greater number of intervals results in a greater smoothness of the spline thereby providing an exacting mathematical representation of a free form illustration.

Referring to FIG. 55f, the line segments 466 and 468 are now represented by splines 474 and 476. Each spline 474, 476 has three control points wherein the pieces of each spline are defined as line segments joined together at their end points.

Referring now to FIG. 56a, the relatively shorter segment spline 476 is converted to a six point spline 476′ and is subsequently manipulated representative of the free form shape. As illustrated in FIG. 56a, five control points and the resulting four intermediate segments is insufficient to accurately represent this free form shape. Control points can be added as desired during free form development to allow morphing in isolated areas on the line. Referring to FIG. 56b, the long segment spline 474 is illustrated with five control points and four intermediate segments.

With reference now to FIG. 56c, each of the splines 474, 476 is changed to splines 474″, 476″ include nineteen control points thereby resulting in eighteen intermediate segments. Thus, the splines 474″, 476″ have been refined to closely resemble the free form shapes. Of course, the greater the number of control points results in a more accurate spline that closely resembles the free form shapes. Once a satisfactory spline is achieved for both splines, such as splines 474″, 476″, these splines may be reproduced as splines 478, 480 respectively for line segments 470, 472.

Upon obtaining a completed tile profile 482 that is composed of reproducible math based shapes that are converted from free form shapes, such as splines 474″, 476″, 478, 480, a template, such as router template 100 can be derived. By utilizing CAD software, a standard stock piece may be added and a nest, cutter path, bearing path and window may be provided such as those provided in the router template 100. Once the router template design is provided in a three dimensional form as CAD geometry, a manufacturing program, such as a three axis CNC program can be written to cut the template from stock. Of course, the tile profile 482 is utilized to design a three dimensional CAD drawing of the die punch 200, tracing template 232, assembly jigs 258, 260, 262, 264, 266, the inlay template 322, and the border template 408; and a three axis CNC program is written for each. Additionally, the blade 392 for the inner corner punch 360 may also be designed in this fashion and machined from a three axis CNC program.

With reference back to the steps provided in FIGS. 55a-56c, the method provided therein can be utilized for converting a free form tessellation into a math based tile profile 482, of which various templates can be fabricated. Also tiles and/or patterns can be manufactured directly in a CNC machine using the tessellation spline conversion method. Alternatively, the steps provided in FIGS. 55a-56c may be utilized for generating a tile pattern without an original free form design.

With reference now to FIG. 57, the pattern geometry 460 is illustrated with the tile profile 482 imbued upon the lattice cell 462. From there, the tile profile 482 may be arrayed through the geometry 460 as illustrated in FIG. 58. Additionally, the tiles may be rendered in desired materials for illustrating the aesthetic result of the tile pattern.

Referring specifically to FIG. 58, a tile pattern may be generated that includes a tessellation pattern 484 that fades into another tessellation pattern 484, which is commonly referred to as a deformation or a geometrical tessellating metamorphosis. The pattern 484 includes a first array 486 and a second array 488 of the tile profile 482. Each tile profile 482 in the first and second arrays 486, 488 includes splines 474′, 476″, 478, 480. A third array 490 is provided around the second array 488 and includes a first partially splined profile 492 and a second partially splined profile 494. Each of the partially splined profiles 492, 494 includes a splined edge to cooperate and engage one of the tile profiles 482; and each of the partially splined profiles 492, 494 retains line segments from the fundamental region 464. For example, first partially splined profile 492 includes spline 480 and line segments 466, 468, 470. Also, second partially splined profile 494 includes spline 474″ and line segments 468, 470, 472.

In accordance with the present invention, a router template may be fabricated for manufacturing tiles for the partially splined profiles 492, 494. The pattern 484 in FIG. 58 includes a series of arrays of tile profiles 496 that are formed from the geometry of the fundamental region 464, thereby being composed of line segments 466, 468, 470, 472. Accordingly, a router template can be fabricated in accordance with the teachings of the present invention to make tiles encompassing tile profile 496. Accordingly, with a series of router templates, or other jigs, a tile pattern can be provided that has fading tessellated patterns, such as that illustrated in FIG. 58.

As discussed above, free form tessellations can be converted into templates and subsequently into tiles for providing a tiled surface representing the artistic tessellation. Accordingly, tessellations can be generated electronically and then subsequently converted into templates for providing tile patterns to represent the tessellation.

One having ordinary skill in the art at the time the invention was made will recognize that a two axis CNC program could be written to manufacture the tiles directly in accordance with the teachings of the present invention. However, CNC machines are costly, generally immobile, and are not generally available to the ordinary woodworker. The router templates, for example, enable a conventional hobbyist to practice the invention in combination with a cutting tool anywhere he or she desires.

With reference now to FIGS. 59-62, a plurality of exemplary tessellation tile patterns are illustrated within the spirit and scope of the present invention. Referring to FIG. 59, the forty-two piece array 252 is revisited, which includes a quantity of seven of the six piece arrays 248. Each of the six piece arrays 248 includes a quantity of six tiles 104.

With reference to FIG. 60, an alternative tessellation tile pattern 498 is illustrated, which comprises a series of arrays 500. One of the arrays 500 is illustrated removed from the pattern 498. Each array 500 includes three identical tiles 502. The tile 502 is provided from a symmetrical polygon. Therefore, the associated template for manufacturing the tile 502 can be fabricated without converting a free form design into splines.

With reference now to FIG. 61, another tessellation tile pattern 504 is illustrated within the spirit and scope of the present invention. The pattern 504 includes a series of arrays 506. Each array 506 includes three identical and symmetrical tiles 508. Each tile 508 is a parallelogram and therefore the steps of converting a free form design into splines may be omitted for the fabrication of the associated template.

With reference now to FIG. 62, an alternative tessellation tile pattern 510 is provided, which is composed of more than one tile profile. Specifically, the pattern includes primary tiles 512 and secondary tiles 514. To fabricate the tile pattern 510, at least a pair of templates are required, each for one of the tiles 512, 514. Of course, a single template could be generated for cutting both tiles 512, 514 in one operation. The tiles 512, 514 of the tile pattern 510 are formed of arcuate math based geometries and therefore the associated templates can be created while omitting the step of converting a free form design into splines. Accordingly, multiple variations of tile patterns and tessellated tile patterns are contemplated within the spirit and scope of the present invention, as illustrated, by example, by the patterns of FIGS. 59-62.

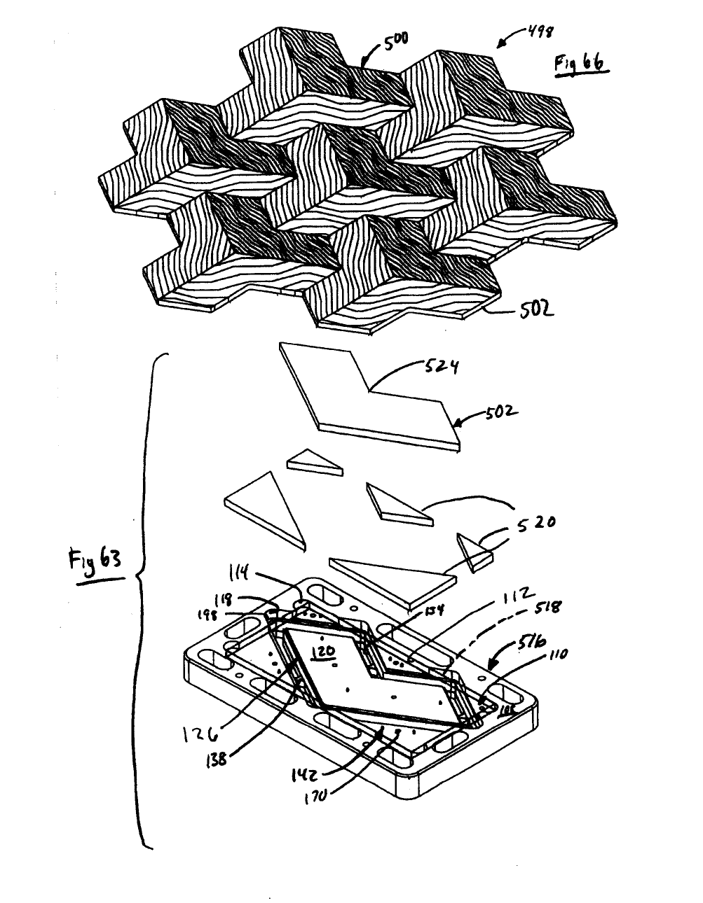

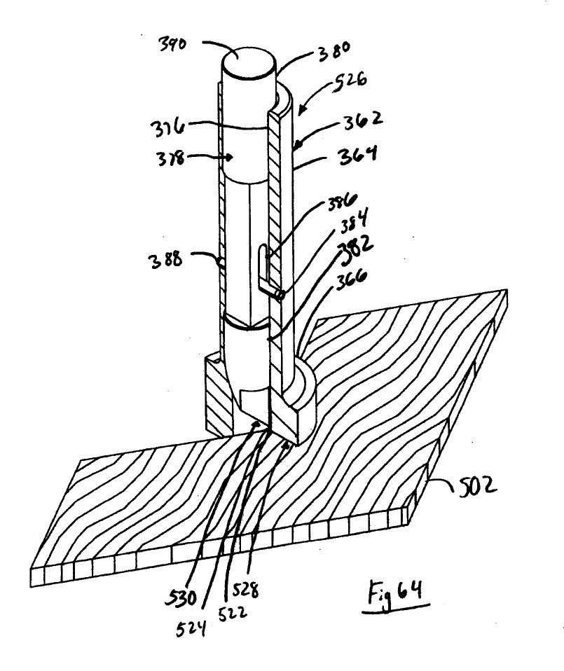

With reference now to FIG. 63, a router template 516 is illustrated within the spirit and scope of the present invention. The router template 516 is similar to the prior embodiment router template 100 and therefore similar elements retain same reference numeral wherein new elements are assigned new reference numerals. A workpiece 518, which is illustrated in phantom in FIG. 63, is inserted into the workpiece nest 112. The cutting operation is performed thereby resulting in the tile 502 and remaining scrap pieces 520. The tile 502 requires an inner corner 522. After the cutting operation, an inner corner scrap portion 524 remains, which must be removed before assembling the tile 502 with other tiles 502.

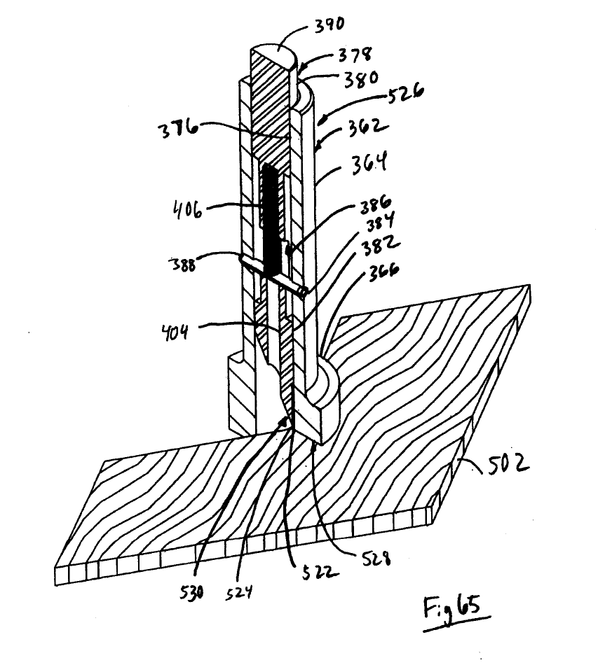

With reference now to FIGS. 64 and 65, an inner corner punch 526 is illustrated for removing the inner corner scrap portion 524. The inner corner punch 526 is similar in design, construction, assembly and operation to that of prior embodiment inner corner punch 360, and therefore same elements retain same reference numerals. The inner corner punch 526 includes a recess 528 that is sized to seat the inner corner punch 526 proximate to the inner corner 522 of the tile 502. The punch shaft 378 includes a blade 530 that is sized to cut and remove the inner corner scrap portion 524. After the inner corner punch operation, the finished tile 502 is provided.

Referring now to FIG. 66, the pattern 498 is illustrated composed of finished tiles 502. FIG. 66 illustrates an exemplar aesthetic pattern that may be provided by the orientation of grain direction for various tiles 502 within the pattern 498.

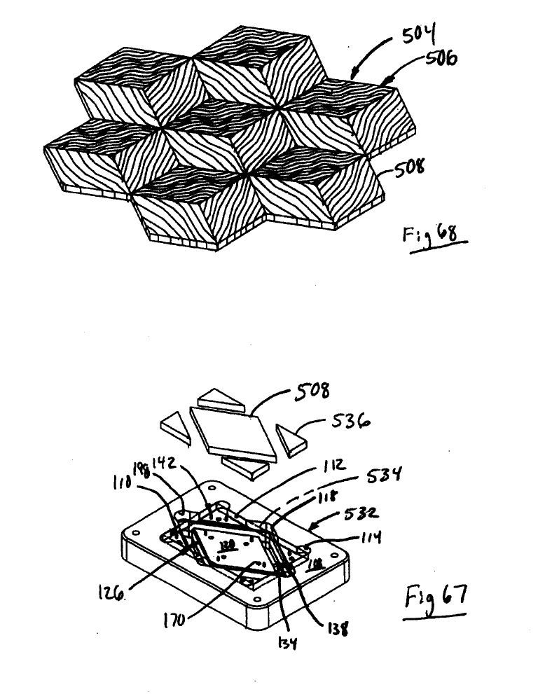

With reference now to FIG. 67, another alternative embodiment router template 532 is illustrated in accordance with the teachings of the present invention. The router template 532 receives a workpiece 534 (illustrated in phantom) in the workpiece nest 112. After the cutting operation, the finished tile 508 and a plurality of scrap pieces 536 are provided.

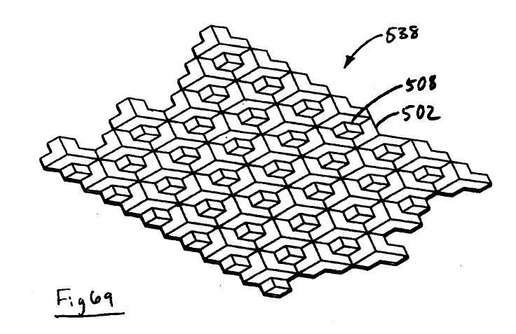

With reference now to FIG. 68, the pattern 504 is illustrated utilizing tiles 508 with the wood grain oriented in various directions thereby resulting in an aesthetic and ornamental display.

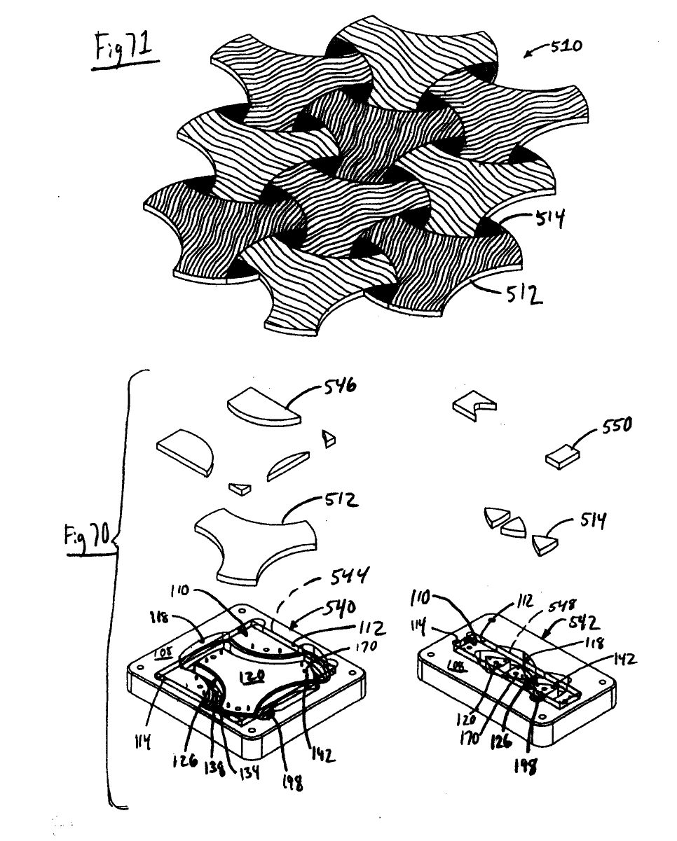

Referring now to FIG. 69, an alternative tessellated tile pattern 538 is illustrated in accordance with the teachings of the present invention. The pattern 538 combines the tiles 502 from FIG. 60 and the parallelogram tiles 508 from FIG. 61 to result in a tile pattern having a different aesthetic appearance.

FIG. 70 illustrates a pair of router templates 540, 542 for manufacturing the primary and secondary tiles 512, 514 respectively. The primary router template 540 receives a workpiece 544 within the workpiece nest 112. After the cutting operation, the finished primary tile 512 and scrap pieces 546 are ejected from the nest 112.

The secondary router template 542 receives a workpiece 548 within the nest 112. After the cutting operation, a quantity of three secondary tiles 514 are provided along with the scrap pieces 550. Since the ratio of primary tiles 512 to secondary tiles 514 is generally one to three within the pattern 510, the secondary router template 542 is provided to generate three tiles 514 to increase the output of the finished tiles.

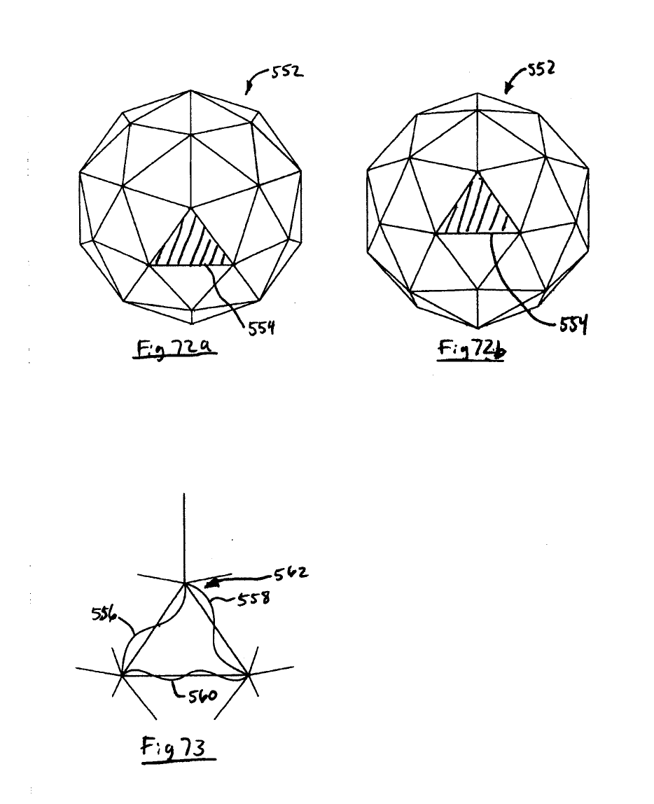

Referring now to FIG. 71, the pattern 510 is illustrated having an ornamental perspective that is provided by variations in wood grains amongst the tiles 512, 514 within the pattern.

The invention contemplates that the templates and methods for manufacturing the templates may be utilized with any tile pattern. Described above are methods and apparatuses for fabricating tessellated tile patterns. Of course, the invention contemplates any tessellated tile pattern, such as the infinite or two-dimensional tile patterns illustrated in the above embodiments and the deformation or metamorphosis tessellation such as that depicted in FIG. 58. Accordingly, the invention also contemplates tessellations having a finite, or three-dimensional geometry that is reduced to a two-dimensional tile pattern.

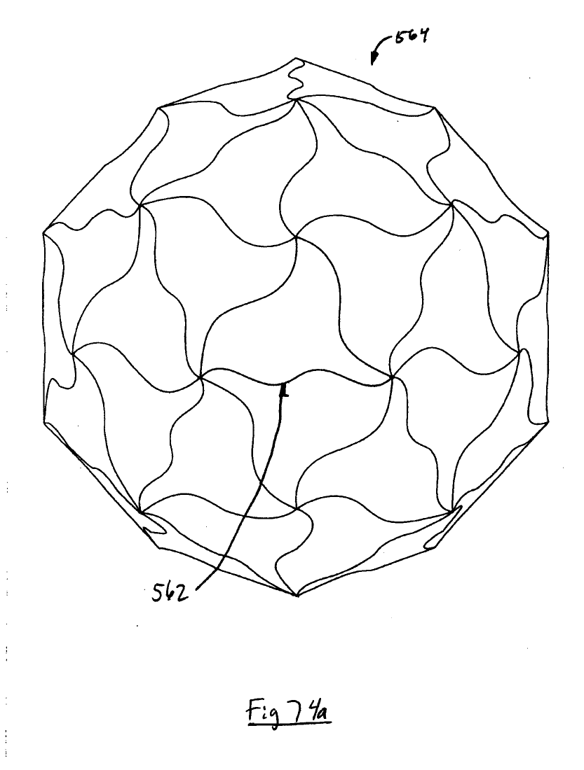

With reference now to FIG. 72a, a three-dimensional polygon geometry 552 is illustrated. The three-dimensional geometry 552 is preferably generated in a CAD environment or a Computer-Aided Modeling (CAM) environment, such as a solid modeling program. Alternatively, the three-dimensional geometry 552 could be generated utilizing conventional mathematics. The three-dimensional geometry 552 may be utilized for generating a finite free form tessellation. The three-dimensional geometry 552 could also be utilized as a finite tessellation in and of itself. Alternatively, the three-dimensional geometry 552 could be provided to match the peaks on a free form design of which a desired tessellated tile pattern is to be generated from. Next, the user selects one of the fundamental regions, such as facet 554 that is illustrated shaded in FIG. 72a. Subsequently, the three-dimensional geometry 552 is rotated such that the facet 554 lies on a plane that is orthogonal to the line of sight, as illustrated in FIG. 72b.

As illustrated in FIG. 73, the facet 554 is focused upon or zoomed into. Splines 556, 558, 560 are generated in the manner of generating splines that is discussed above with reference to FIGS. 55a-56c. The splines 556, 558, 560 could represent a predefined free form tessellation or could be originally created at this step. For the given geometry, splines 556 and 558 are identical and are arrayed about the intersection of these splines so that a resulting tile profile 562 can be assembled with adjacent similar tile profiles 562. Additionally, the spline 560 is formed symmetrically such that the spline 560 can be assembled with the spline 560 of an adjacent tile profile 562. In the alternative, a free form design with no tessellations can be prepared using the spline conversion method and an ornate non-tessellated design can be generated with high precision directly in a CNC machine.

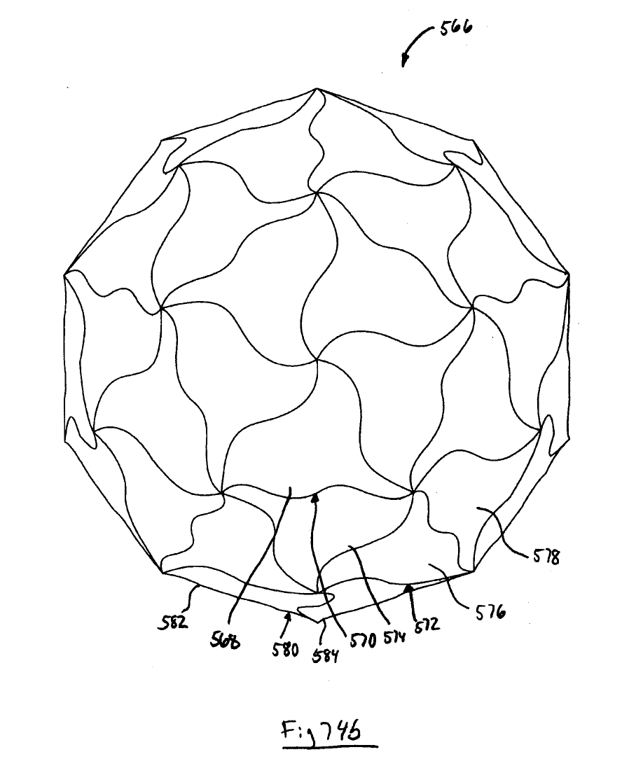

Referring now to FIG. 74a, the tile profile 562 is duplicated for each facet 554 within the three-dimensional geometry 552. From this view in FIG. 74a, a tile pattern 564 could be generated by flattening the three-dimensional view into two-dimensional splines. Subsequently, a router template could be generated for each unique two-dimensional tile profile or the tiles can be manufactured directly in a CNC machine.

Alternatively, the three-dimensional spline geometry 552 is rotated back to its original position as illustrated in FIG. 74b, thereby providing repeatability in the outer arrays. A tile pattern 566 is generated from this view. The three-dimensional geometry 552 is flattened into a series of two-dimensional splines. A router template is generated for each unique tile profile. For example, a router template is generated for fabricating each tile profile 568 within a central five piece array 570 within the tile pattern 566. One of the tile profiles 568 is incorporated into a nest of a stock piece and a cutter path, bearing path and window slots are provided around the tile profile 568. Subsequently a three axis CNC program is written to cut the template from stock.

The tile pattern 566 includes a secondary array 572 oriented around the five piece array 570. The secondary array 572 includes a quantity of fifteen tiles, with three repeated profiles 574, 576, 578. A router template is provided for each of these three profiles 574, 576, 578 and subsequently tiles are fabricated for each of these profiles 574, 576, 578 within the secondary array 572. The tile pattern 566 also includes a tertiary array 580 oriented around the secondary array 572. The tertiary array 580 includes a quantity of ten tiles, having two repeating tile profiles 582, 584. Accordingly, a router template is generated for each of the tile profiles 582, 584 to generate the tiles within the tertiary array 580. Accordingly, within the teachings of the present invention, a three-dimensional finite tessellation, such as the one illustrated in FIG. 74b is reduced to two-dimensional tiles which are incorporated into an ornamental surface, such as a furniture top or the like.

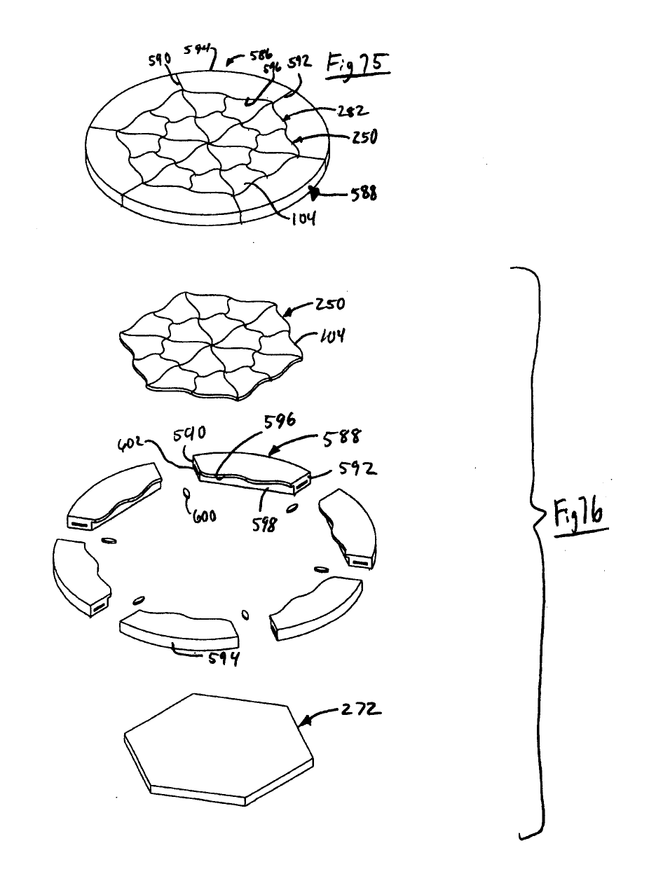

With reference now to FIG. 75, a table top, such as end table top 586 is illustrated in accordance with the teachings of the present invention. The table top 586 includes the eighteen piece array assembly 282. The table top 586 is illustrated exploded in FIG. 76. The eighteen piece array assembly 282 includes the eighteen piece array 250 and the eighteen piece array assembly plate 272. The table top 586 includes a plurality, specifically a quantity of six, table top chords 588. Each table top chord 588 includes a first and second mitered end 590, 592. An external region of each table top chord 588 is provided with an arcuate segment 594. An inward facing region of the table top chord 588 is sized to receive the eighteen piece array assembly 282. Specifically, each table top chord 588 includes an inlay aperture segment 596. Upon assembly of the table top chords 588, the inlay aperture segments 596 collectively provide the inlay aperture for receiving the eighteen piece array 250. Displaced beneath each inlay aperture segment 596 is an elongate recess 598 for collectively receiving the eighteen piece array assembly plate 272.

The eighteen piece array assembly 282 is assembled within the eighteen piece array assembly jig 260. Subsequently, the table top chords 588 are assembled about the eighteen piece array assembly 282. Sequential table top chords 588 are secured together by biscuit joining, which includes a biscuit 600 that is received within aligned slots 602 disposed within the first mitered end 590 and the second mitered end 592 of sequential table top chords 588. The table top chords 588 and the eighteen piece array assembly 282 are subsequently adhered or fastened together. Although biscuit joining is illustrated, it is obvious to one having ordinary skill in the art at the time the invention was made to utilize any conventional woodworking methods of joining adjacent wooden pieces together, such as tongue and groove joining, dovetail joining, pocket jigged fasteners, or the like. Alternatively, the table top chords 588 and the eighteen piece array assembly plate 272 could be assembled together and the eighteen piece array 250 could be assembled within the inlay aperture formed by the segments 596.

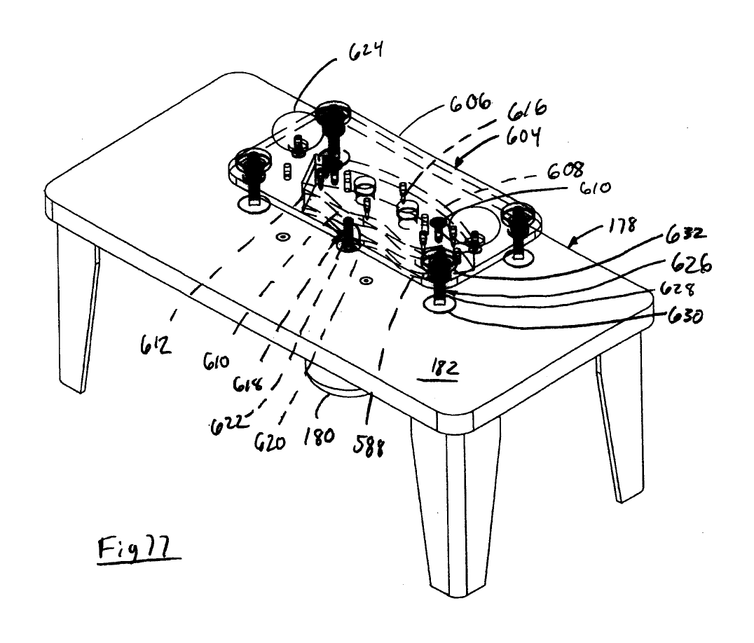

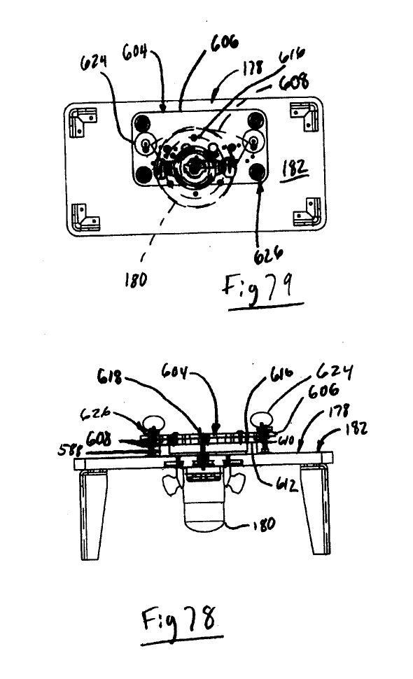

With reference now to FIGS. 77-80, a table top chord jig 604 is illustrated in accordance with the teachings of the present invention for fabricating the table top chords 588. The table top chord jig 604 is illustrated in cooperation with a conventional router table, such as router table 178. The table top chord jig 604 includes a transparent plate 606, which is formed from rectangular stock and is generally oversized with respect to the table top chord 588. The table top chord jig 604 includes a table top chord template 608, which is secured to the underside of the plate 606 by a plurality of fasteners 610. The table top chord template 608 includes an external bearing path 610. The underside of the table top chord template 608 provides a nest surface 612 for receiving a workpiece 614. The table top chord template 608 includes a plurality of retaining pins 616 for piercing the workpiece 614 and retaining the workpiece 614 relative to the table top chord template 608. Preferably, the table top chord 588 is oriented with its underside against the nest surface 612 so that the retaining pins 616 do not pierce the finished top surface.

The router table 178 includes the router 180 with a router bit 618 extending through the top surface of the router table 178. The router bit includes a guide bearing 620 for engaging the bearing path 610 of the table top chord template 608. The router bit 618 includes a cutter 622 for cutting the workpiece 614, when the router bit 618 is extended to a height wherein the guide bearing 628 engages the bearing path 610.

The table top chord jig 604 includes a pair of ergonomic handles 624 extending from the plate 606 at spaced apart locations for facilitating ergonomic manipulation of the table top chord jig 604 relative to the router table 178. Additionally, a plurality of leveling legs 626 are provided for spacing the plate 606 at a height relative to the top surface of the router table 178. The leveling legs 626 permit fine tuning of the workpiece 614 thickness parallel to the table top 182.

Each leg 626 includes a threaded bolt 628 extending orthogonally from the plate 606. Each leveling leg 626 includes a foot pad 630 at the distal end of the threaded bolt 628. The foot pad 630 is formed of a generally sturdy material having a contacting surface of reduced friction to permit the foot pad 630 to glide along the table surface of the router table 178. Each threaded bolt 628 is threadably received within the plate 606 for height adjustment of the plate 606 and leveling of the plate 606 relative to the table surface of the router table 178. Additionally, each leveling leg 626 includes a manual nut 632 that is also threadably engaged with the threaded bolt to serve as a jam nut for locking the respective leveling leg 626 relative to the plate 606. In operation of adjustment of a leveling leg 626, a user loosens the manual nut 632 and subsequently adjusts the threaded bolt 628 to a desired height relative to the plate 606. Once a desired height is obtained, the manual nut 632 is tightened to lock the leveling leg 626 in place.

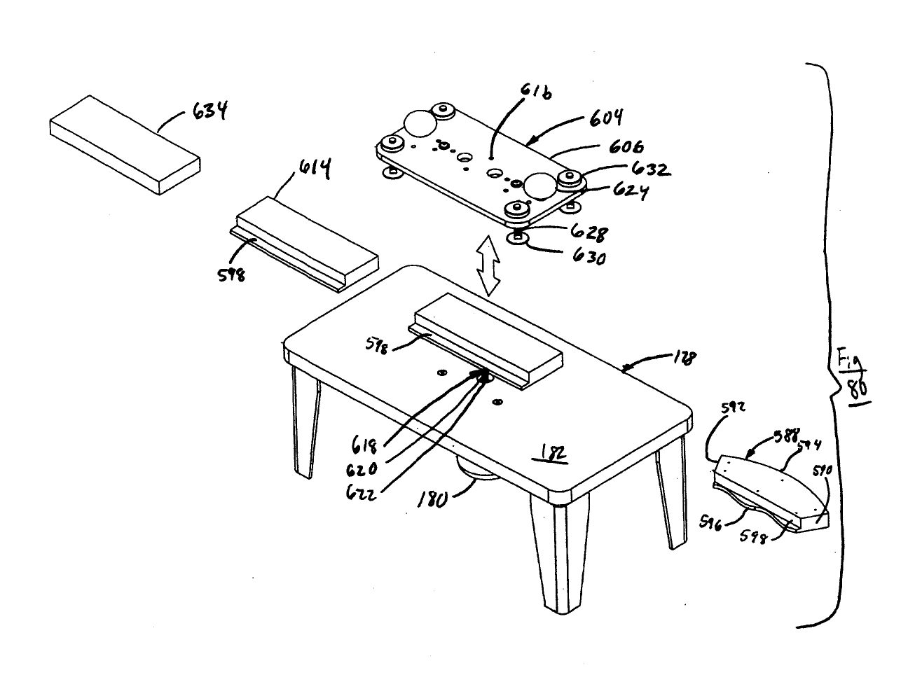

Referring specifically now to FIG. 80, the cutting operation of the table top chords 588 is illustrated in detail. Specifically, a stock workpiece 634 is provided such as a wooden board. The stock piece 634 is cut to include the recess 598. The recess 598 may be cut by a router, a saw table or the like. Once the recess 598 is cut the workpiece 614 is provided. The workpiece 614 is secured to the table top chord jig 604 by use of the retaining pins 616 or any other retaining mechanism. Subsequently, the table top chord jig 604 is placed upon the table surface of the router table 178. The user translates the table top chord jig 604 towards the router bit 618 until the guide bearing 620 engages the bearing path 610 as the cutter 622 begins cutting the workpiece 614. The user translates the table top chord jig 604 relative to the router bit 618 such that the entire perimeter of the bearing path 610 translates along the guide bearing 620 of the router bit 618. During this cutting operation, the first and second miter ends 590, 592, the arcuate segment 594 and the inlay aperture segment 596 are all cut into the table top chord 588. Subsequently, the table top chords 588 are subjected to staining, dyeing, painting or the like if desired and then assembled into the table top 586 as discussed above with reference to FIGS. 75 and 76.

Referring again to the manufacturing of jigs such as router templates 100, a tile pattern or tessellated tile pattern can be developed based upon mathematical operations or merely by free form, artistic expression. The user then fabricates tiles associated within the tile pattern or generates templates to fabricate the tiles. Alternatively, if customers of the user desire jigs or templates for fabricating tiles, the user can submit a tile pattern, whether free form or mathematical, to the user. The user then fabricates jigs and/or templates for fabricating tiles within the tile pattern.

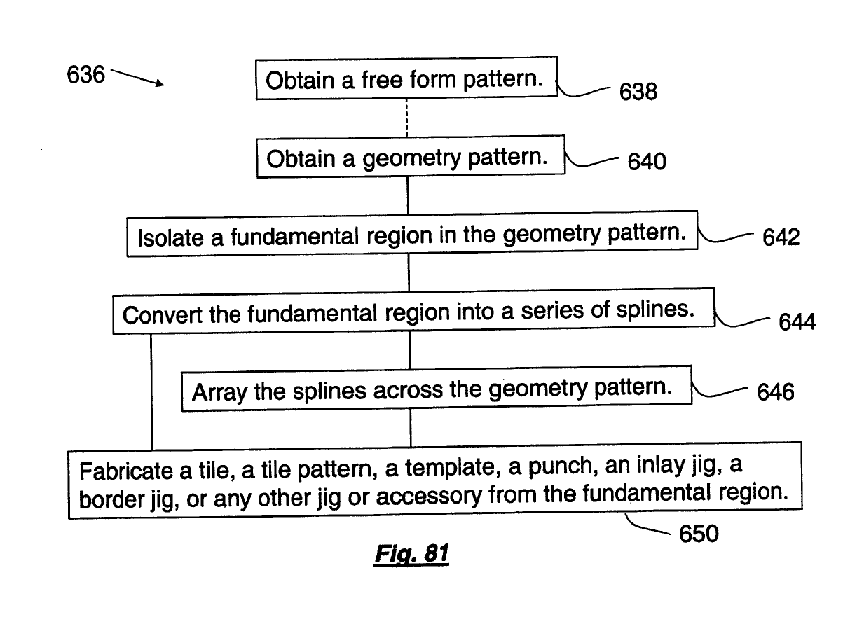

Referring now to FIG. 81, a flowchart 636 is illustrated summarizing the steps in generating a mathematical pattern from a free form pattern; in generating a free form mathematical pattern; or in generating a tile, a tile pattern, a template, a punch, an inlay jig, a border jig or any other jig or accessory from a free form or geometry pattern. Block 638 is the step of obtaining a free form pattern. Of course, this step may be omitted, as the free form pattern may be generated after a geometry pattern has been selected. The next or first step is obtaining a geometry pattern as in 640. If a free form pattern has already been obtained or selected as in block 638, then a geometry pattern is selected in block 640 that corresponds with the free form pattern. Otherwise, a geometry pattern is designed or selected in block 640, from which a free form pattern is to be created from. Of course, as described above with reference to FIGS. 55a to 58 and 72a to 74b, the geometry pattern may be two dimensional or three dimensional.

Subsequently, as indicated by block 642 in the flow chart 636, a fundamental region of the geometry pattern is isolated. In block 644, the fundamental region is converted into a series of splines to represent the free form pattern of block 638, or to generate a mathematical free form pattern. Subsequently, as indicated by block 646, the splines are arrayed at least partially across the geometry pattern to provide an arrayed pattern. Of course, block 646 may be omitted, as the fundamental region may be immediately fabricated. Referring now to block 650, the fundamental region can be utilized to fabricate a tile or a tile pattern, for example using a two dimensional CNC program. Of course, a template, punch, inlay jig, border jig or any other jig or any associated accessory may be fabricated from the fundamental region.

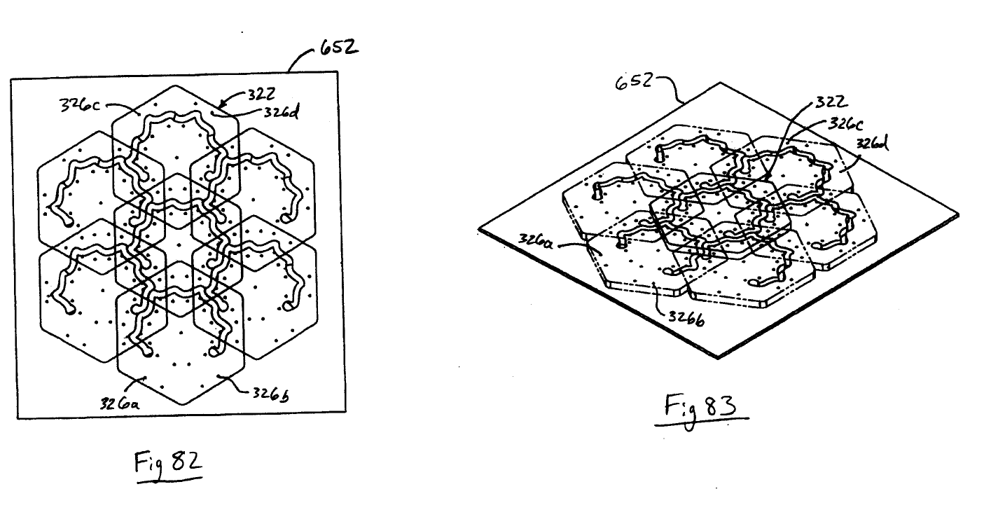

Referring now to FIGS. 82 and 83, a workpiece 652 is illustrated in cooperation with the inlay template 322. The inlay template 322 is utilized for cutting the inlay aperture 352 for the six piece array 248 as described with reference to FIGS. 29 to 42. Additionally, the inlay template 322 is employed for cutting an inlay aperture for any number of adjacent interlocking six piece arrays 248. As illustrated in FIGS. 82 and 83, the inlay template 322 is utilized for cutting a plurality of interconnecting inlay apertures 352 for creating an inlay aperture for the forty-two piece array 252. In order to reposition the inlay template 322 so that each inlay aperture intersects correspondingly to collectively retain the adjacent six piece arrays 248, the symmetrically arrayed retaining pins 326 are utilized.

Referring again to FIG. 29, the user utilizes the inlay template 322 with retaining pins 326 at positions labeled 326a and 326b. In order to advance the inlay template 322 to cut an adjacent inlay aperture, retaining pins 326 are utilized at locations 326c and 326d and these retaining pins are placed in the apertures formed by retaining pins 326a and 326b respectively. Depending on the size of the inlay aperture, and the number of six piece arrays 248 to be retained therein, this process can reposition the inlay template 322 repetitively. For example, as illustrated in FIGS. 82 and 83, this repositioning process is illustrated for repositioning the inlay template 322 outwardly from the central position six times. Each time the inlay template 322 is repositioned to an outward orientation, the cutting operation is performed as described with FIGS. 29-42.

With reference now to FIGS. 84a and 84b, a spring-loaded retaining pin 654 is illustrated in accordance with the teachings of the present invention. Specifically, the spring-loaded retaining pin 654 is illustrated in an unloaded position in FIG. 84a, and in a loaded position in FIG. 84b. The spring-loaded retaining pin 654 includes a longitudinal body 656 that is sized to be received and retained within a pin aperture of a template. The body 656 includes a longitudinal bore 658 formed therethrough for receiving a pin shaft 660 at least partially therein. Each pin shaft 660 includes an anvil 662, a pair of axially opposed shoulders 664, 666 and a pin end 668. A transverse slot 670 is formed at least partially through the body 656. The spring-loaded retaining pin 654 is assembled such that a compression spring 672 is disposed about the pin shaft 660 in engagement with the first shoulder 664. A retaining clip 674 is received within the transverse slots 670, and is disposed between the first and second shoulders 664, 666 and in contact with the adjacent end of the spring 672.

In operation, the spring 672 urges the pin shaft 660 to a retracted position when unloaded. In order to extend the pin end 668 into an associated workpiece, the anvil 662 is translated towards the body 656 such that the spring 672 is compressed and the pin end 668 extends from the body 656 and pierces the associated workpiece. The pin shaft 660 remains in its extended position, as illustrated in FIG. 84b, by a fastener or the like, such as a set screw engaged in the associated template and placed above the anvil 662 to prevent the pin shaft 660 from retracting. When it is desired to remove the workpiece from the associated template, the fastener is removed such that the spring 672 urges the pin shaft 660 to the unloaded position, corresponding to the engagement of the second shoulder 666 upon the retaining clip 674.

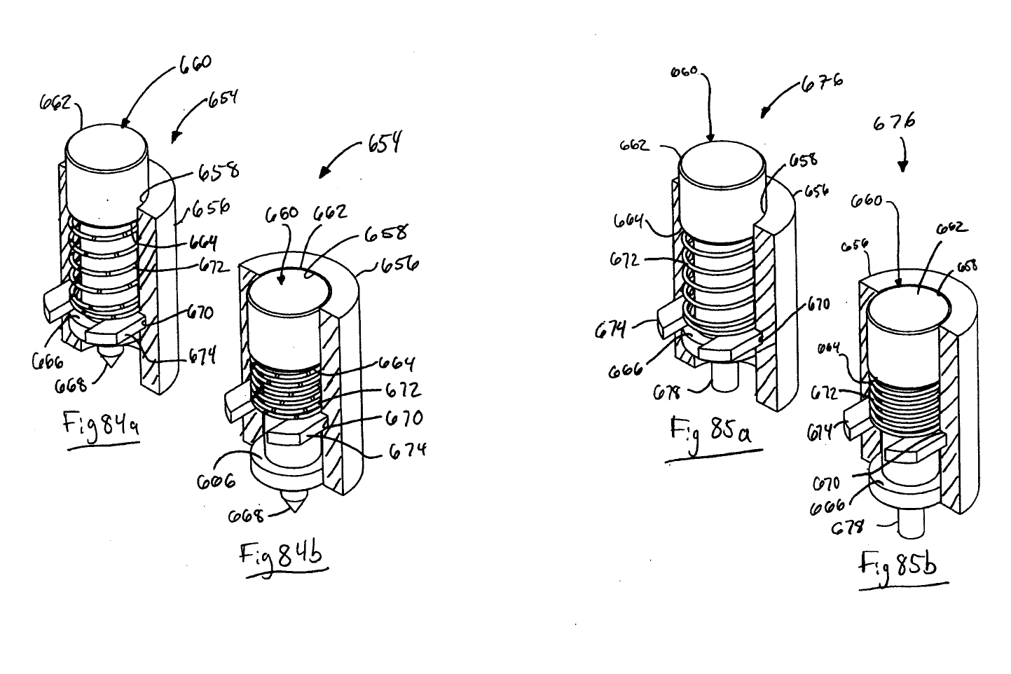

Referring now to FIGS. 85a and 85b, a spring-loaded ejection pin 676 is illustrated in accordance with the teachings of the present invention. The spring-loaded ejection pin 676 is similar in construction to that of the spring-loaded retaining pin 654 and therefore same or similar elements retain same reference numerals wherein new elements are assigned new reference numerals. Instead of a pin end 668, the spring-loaded ejection pin 676 is equipped with a blunt ejection pin end 678. The spring-loaded ejection pin 676 is received within an aperture formed in an associated template and maintains the unloaded position illustrated in FIG. 85a during the cutting operation. Upon completion of the cutting operation, the user translates the pin shaft 660 by striking the anvil 662 so that the pin shaft is translated as illustrated in FIG. 85b. Upon this translation, the ejection pin end 678 engages the associated workpiece or scrap piece thereby ejecting the piece from the template. The spring 672 actuates the pin shaft 660 upward so that it retains the free position illustrated in FIG. 85a.

In summary, the present invention provides high tolerance, high precision and repeatable accuracy tiles that can be manufactured at a minimized cost and assembled with relative ease without requiring gap filling as is associated with prior art tiling. Additionally, the present invention enables the end user to fabricate the tiles, thereby enhancing the woodworking experience when tiling a surface or providing inlays in furniture. The present invention provides templates and jigs for fabricating the tiles from the initial stock or workpiece to a finished product to be assembled in the tiling operation or incorporated into furniture. The invention also enables the end user to fabricate the associated jigs or templates of the end user's interest or design. The present invention also provides many accessories to be utilized in accordance with the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A punch for cutting a tile from a workpiece, the punch comprising:
a body including:
a central portion;
a cutting blade formed about the central portion; the cutting blade being configured to cut the tile in a predetermined shape,
an impact receiving surface for receiving an impact,
a recess formed inboard of the cutting blade for receiving the tile during the cutting operation, and
a resilient member provided within the recess for ejecting the tile.

2. The die punch of claim 1 wherein the resilient member is an elastomeric pad that is disposed on the first surface.

3. The die punch of claim 1 wherein the central portion has a planar surface and the cutting blade extends in a direction that is normal to the planar portion and has an inner side that is perpendicular to the first surface and an outer side that is disposed of an acute angle relative to the inner surface at a distal end thereof to form a cutting edge.
